(19) United States
(12) Patent Application Publication
(10) Pub. No.: US 2011/0163885 A1
(43) Pub. Date: Jul. 7, 2011

(54) ADJUSTABLE THERAPEUTIC MATTRESS

(76) Inventors: Craig Poulos, Wilmette, IL (US); Timothy J. Fischer, Chicago, IL (US); Joseph Immordino, Hoffman Estates, IL (US)

(21) Appl. No.: 12/833,684

(22) Filed: Jul. 9, 2010

Related U.S. Application Data
(63) Continuation of application No. 12/584,540, filed on Sep. 8, 2009, now abandoned.
Application No. 12/584,540 is a continuation of application No. 11/502,633, filed on Aug. 10, 2006, now Pat. No. 7,587,776.
Application No. 11/502,633 is a continuation-in-part of application No. 11/349,683, filed on Feb. 8, 2006, now Pat. No. 7,536,739.
(60) Provisional application No. 61/270,481, filed on Jul. 9, 2009.
(60) Provisional application No. 60/707,074, filed on Aug. 10, 2005.

(51) Int. Cl. A47C 27/10; G08B 21/00

(52) U.S. Cl. 340/626; 5/710

(57) ABSTRACT

A therapeutic mattress is provided having a base layer, a plurality of separate air cell sections, an air source and a valve. The separate air cell sections have a plurality of fluidly interconnected air cell members extending vertically from a bottom wall. The air cell members of the air cell sections are independently moveable in a plurality of directions. The valve is fluidly connected to the plurality of separate air cell sections. The air source is connected to the valve to independently increase the air pressure in the air cell sections to a desired air pressure.

### CROSS-REFERENCE TO RELATED APPLICATIONS

This application is a continuation of U.S. Provisional Patent Application No. 61/270,481, filed on Jul. 9, 2009, and this application is also a continuation of U.S. patent application Ser. No. 12/584,540, filed Sep. 8, 2009, which is a continuation of U.S. patent application Ser. No. 11/502,633 (now U.S. Pat. No. 7,587,776), filed Aug. 10, 2006, which is a continuation-in-part of U.S. patent application Ser. No. 11/349,683 (now U.S. Pat. No. 7,536,739), filed Feb. 8, 2006, which is a continuation-in-part of U.S. Provisional Patent Application Ser. No. 60/707,074, filed Aug. 10, 2005, all of which above-identified applications are expressly incorporated herein by reference and made a part hereof.

### FEDERALLY SPONSORED RESEARCH OR DEVELOPMENT

Not Applicable.

### TECHNICAL FIELD

The present invention relates generally to a mattress for a hospital bed, and more specifically to a therapeutic mattress having an adjustable air composite patient support surface.

### BACKGROUND OF THE INVENTION

Therapeutic mattresses, including therapeutic overlays which assist in preventing bed sores, for hospital beds are well known in the art. While such mattresses and overlays according to the prior art provide a number of advantageous features, they nevertheless have certain limitations. The present invention seeks to overcome certain of these limitations and other drawbacks of the prior art, and to provide new features not heretofore available. A full discussion of the features and advantages of the present invention is deferred to the following detailed description, which proceeds with reference to the accompanying drawings.

### SUMMARY OF THE INVENTION

The present invention generally provides a therapeutic mattress. In one embodiment the therapeutic mattress has a base layer, a patient support layer above the base layer, and an encasing over the base layer and the patient support layer. The therapeutic mattress is provided to assist in preventing bed sores and decreasing existing bedsores on patients. Preferably the patient support layer has a plurality of air cell sections, the internal air pressure of which can be independently monitored and adjusted.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of one embodiment of a therapeutic bed system;

FIG. 2 is a perspective view of the bed system of FIG. 1, showing a patient support layer exploded from a plenum layer;

FIG. 3 is a perspective view of a head section of the patient support layer;

FIG. 4 is a bottom view and a top view of the head section of the patient support layer;

FIG. 5 is a perspective view of a torso section of the patient support layer;

FIG. 6 is a perspective view of a lower body section of the patient support layer;

FIG. 7 is a top and bottom perspective view of an activation section of the patient support layer;

FIG. 7A is a perspective view of an alternate embodiment of an array of cells for the patient support layer as provided in an activation section;

FIG. 7B is an exploded view of a portion of the array of patient support cells;

FIG. 7C is a top plan view of the array of patient support cells of FIG. 7A;

FIG. 7D is a bottom plan view of the array of patient support cell of FIG. 7A;

FIG. 8 is a bottom view, a side view and a top view of the activation section of the patient support layer;

FIG. 9 is a perspective view of the bed system showing rotational elements extending from an underside of the patient support layer;

FIG. 10A is a perspective view of another embodiment of a therapeutic bed system showing the activation section and the patient support layer exploded from the plenum layer;

FIG. 10B is a perspective view of the activation section of FIG. 10A having two plenum chambers;

FIG. 11 is a perspective view of a blower assembly of the bed system;

FIG. 12 is a perspective view of an activation valve assembly mounted to a lower surface of the plenum layer;

FIG. 13 is a perspective view of the activation valve assembly;

FIG. 13A is a perspective view of an alternate embodiment of the activation valve;

FIG. 13B is an exploded view of the activation valve of FIG. 13A;

FIG. 14 is an exploded view of the activation valve assembly;

FIG. 15 is an end view of the activation valve assembly;

FIG. 16 is a cross-section of the activation valve assembly taken along lines 16-16 of FIG. 15;

FIG. 17 is a schematic of the valve assembly of the bed system;

FIG. 18 is a bottom view of another embodiment of an alternating pressure mattress assembly;

FIG. 19 is a schematic view of a cell of the alternating pressure mattress of FIG. 18;

FIG. 20 is a block diagram of a replacement therapeutic mattress assembly;

FIG. 21 is an assembled perspective view of one embodiment of a therapeutic mattress with the mattress cover partially open;

FIG. 22 is a top view of the therapeutic mattress of FIG. 21 with the mattress cover removed;

FIG. 23 is an exploded perspective of the therapeutic mattress of FIG. 21 with the mattress cover removed;

FIG. 24 is a side cross-sectional elevation view of the mattress through line 24-24 of FIG. 21;

FIG. 25 is an assembled perspective view of another embodiment of a therapeutic mattress with the mattress cover partially open;

FIGS. 26A and 26B are different embodiments of a bottom member of the therapeutic mattress;

FIG. 27 is an assembled perspective view of another embodiment of a therapeutic mattress with all four patient zones made of inflatable components;

FIG. 28 is a schematic view of one embodiment of an adjustable therapeutic mattress;

FIG. 29A is a schematic perspective view of another embodiment of an adjustable therapeutic mattress;

FIG. 29B is an end view of the mattress of FIG. 29A;

FIG. 30 is a schematic view of one embodiment of an adjustable therapeutic mattress; and,

FIG. 31 is a schematic view of another embodiment of an adjustable therapeutic mattress.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

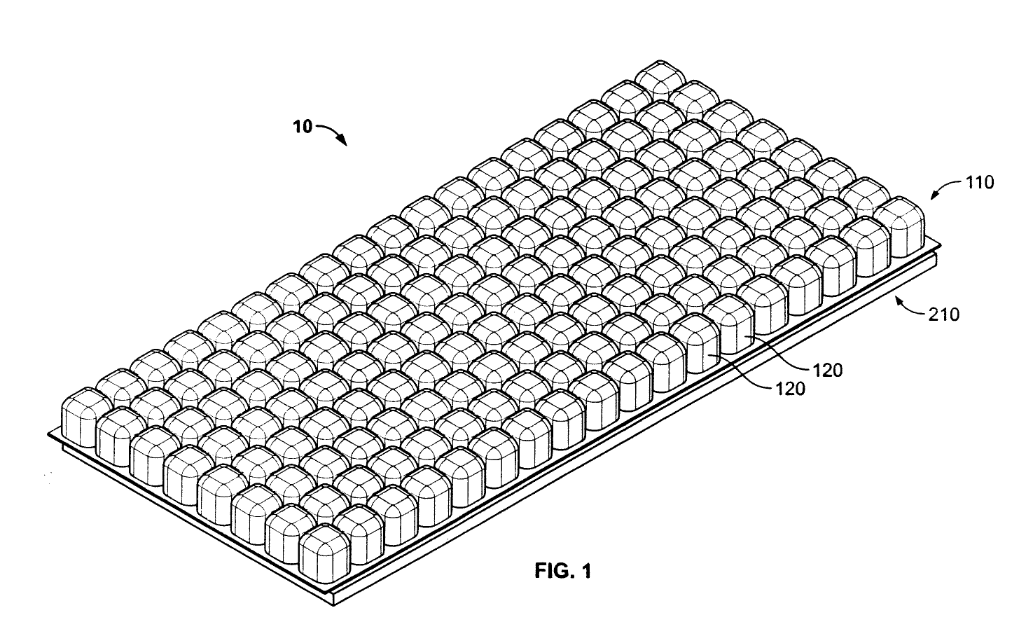

A dynamic therapy bed system 10 is shown in the FIGS. 1-20. Although the bed frame or support structure is not shown, it is understood that the system 10 is intended for use with a variety of conventional bed frames including those found in hospitals and health care facilities. In one embodiment, the bed system 10 includes a patient support layer 110, a plenum layer 210, a blower assembly 310, and an activation valve assembly 410. As explained in greater detail below, the bed system 10 provides treatment to a patient through several modes of operation, including standard, alternating pressure, percussion, vibration, rotation, wound therapy and various combinations thereof.

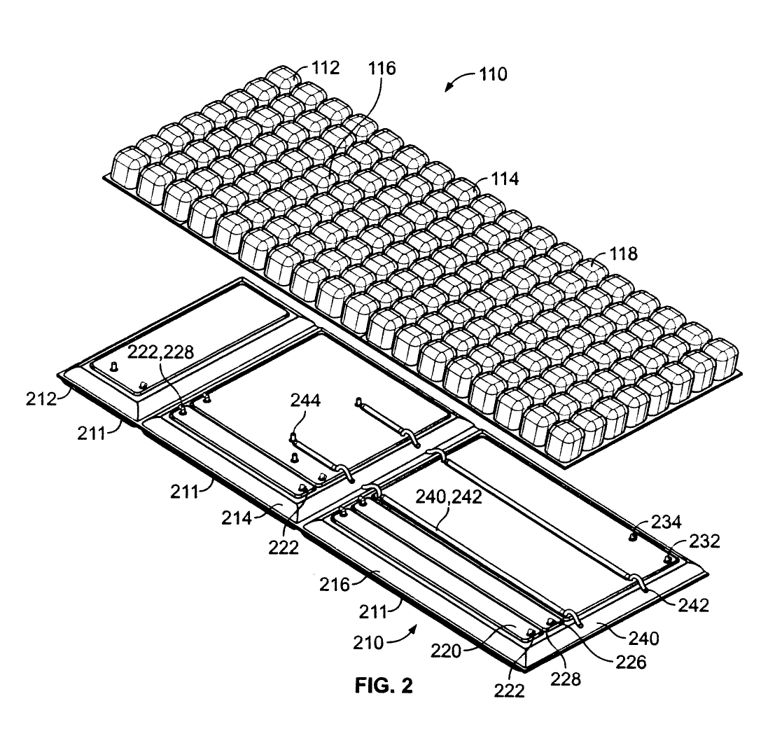

Referring to FIGS. 1-2, the patient support layer 110 is the uppermost layer of one embodiment of the bed system 10 or mattress and includes a head section 112, a torso section 114, an activation section 116, and a lower body section 118. As explained below, in one embodiment the activation section 116 is positioned within the torso section 114 and is configured to apply alternating pressure, percussion and/or vibration forces to treat the patient. Alternatively, the entire patient support layer 110 may be an activation section 116, such as with an full alternating pressure mattress. In another configuration of the bed system 10, the torso section 114 and head section 112 are combined as an integrated unit that receives the activation section 116. The head, torso, activation and lower body sections 112-118 each have an array of cells 120 that are in fluid communication with other cells 120 in each respective section 112-118. The cells 120 of the sections 112-118 collectively define a patient support surface. The cells 120 may be comprised of closed cell configurations (i.e., wherein air pressure is generally maintained at a constant pressure in the mattress) or open-cell configurations (i.e., wherein a blower or other provider of air is connected to the mattress such that air pressure in the chamber of the mattress can be varied real time). Alternatively, any section of the patient support layer 110, other than the activation section 116, may be made of a non-inflatable component, such as foam, with an activation section 116 provided in the non-inflatable component as necessary.

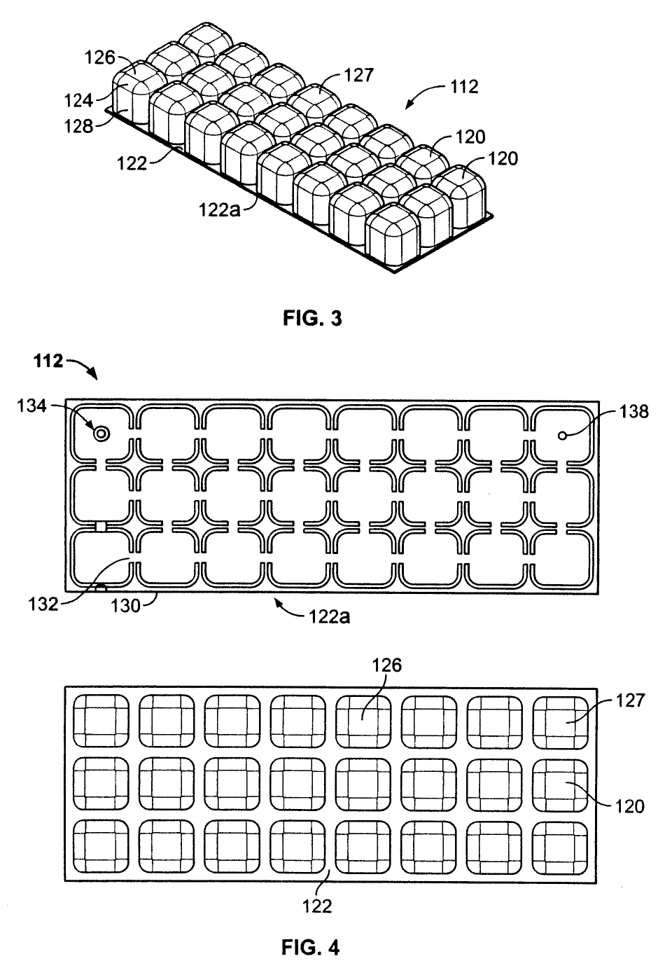

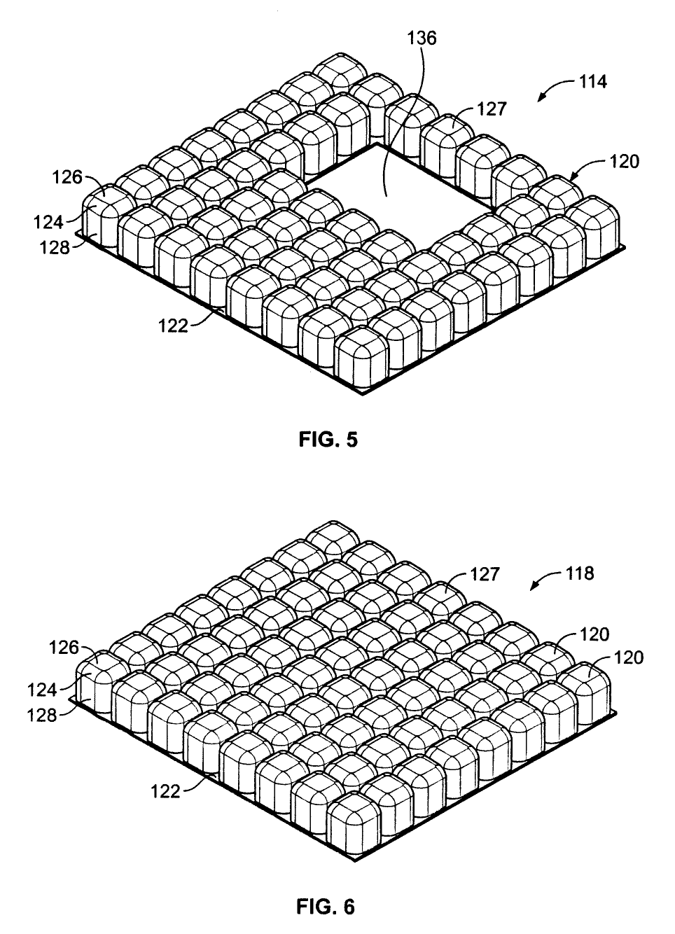

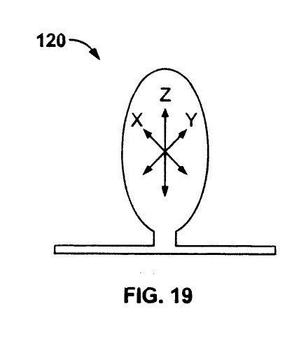

As shown in FIGS. 3 and 4, the head section 112 has an array of cells 120 extending from a base 122. Each cell 120 has an upper portion 124 with a top wall 126, and a lower portion 128. The top walls 126 collectively define a head patient support surface 127 of the head section 112. The top wall 126 may by flat or have an alternate configuration such as a peaked star or otherwise as shown herein. The lower portion 128 of each cell 120 includes a side wall arrangement 130, wherein each interior side wall 130 includes an opening 132. As shown in FIG. 5, in one embodiment the openings 132 are aligned to provide fluid communication between the cells 120, allowing the blower assembly 310 or other provider of air to supply air simultaneously to all cells 120 that are in fluid communication within the section. In one embodiment the exterior side walls 130 lack an opening 132 since there is no cell 120 beyond the periphery 122a of the base 122. In one embodiment, the cells 120 have an overall height of between 2.5″ and 10″, and preferably approximately four inches, however, the overall height varies with the design parameters of the bed system 10. Accordingly, the cells 120 are generally elongated vertically as opposed to typical cells on certain alternating pressure pads. In one embodiment, the cells 120 are independent in structure in that they can attain movement in at least six degrees of freedom as shown in FIG. 19, including movement in both directions in an x-axis, both directions in a y-axis and both directions in the z-axis. By having a mattress that can move air from one cell 120 to adjoining cells 120 as necessary, and by having air cells 120 that are able to move in multiple directions assists in being able to immerse the patient in the mattress 10 to reduce the overall pressure on the surface of the contact areas of the patient.

The head section 112 includes an air supply fitting 134 and an exhaust or relief fitting 138. As explained herein, with any section of the patient support layer 110 the inlet port 134 may also be utilized as an exit port such that only one port per chamber is necessary. The blower assembly 310 supplies air via the plenum layer 210 or directly to the cells 120 in the head section 112 to support the patient's head when it rests on the patient support surface 127. The fitting 134 depends from a lower surface of the base 122. In one embodiment, the head section 112 has a three by eight array of cells 120 providing a rectangular configuration to the section 112, however, the precise number of cells 120 in the array can vary as well as the resulting configuration of the head section 112. The cells 120 and the base 122 are formed from urethane, neoprene, or any other material having similar strength and durability traits, wherein the material thickness is preferably greater than 10 mils.

Referring to FIG. 5, in one embodiment the torso section 114 has an array of cells 120 that are typically similar to those found in the head section 112. The top walls 126 of the cells 120 collectively define a torso patient support surface 127. In an embodiment with an activation section 116, the torso section 114 also has an aperture 136 configured to receive the activation section 116. Like the head section 112, the torso section 114 includes an air supply fitting 134 and an exhaust or relief fitting 138. The blower assembly 310 supplies air either directly to the cells 120 or via the plenum layer 210 to the cells 120 in the torso section 114 to support the patient's torso when it rests on the support surface 127. In one embodiment, the torso section 114 has a seven by eight array of cells 120 providing a rectangular configuration to the section 114, wherein a number of cells 120 are omitted to define the aperture 136. The aperture 136 is cooperatively dimensioned to receive activation section 116, so the precise configuration of the aperture 136 varies with the design parameters of the bed system 10. As mentioned above, the head and torso sections 112, 114 can be combined into a single unit of the patient support layer 110.

As shown in FIG. 6, the lower body section 118 also has an array of cells 120 that are similar to those found in the head and torso sections 112, 114. The top walls 126 of the cells 120 collectively define a lower patient support surface 127 of the section 118. Like the head section 112, the leg section 118 includes an air supply fitting 134 and an exhaust or relief fitting 138. The blower assembly 310 supplies air via the plenum layer 210 or directly to the cells 120 in the lower body section 118 to support the patient's lower body region when it rests on the support surface 127. In one embodiment, the lower body section 118 has an eight by eight array of cells 120 providing a square configuration to the section 118, however, the configuration can be varied depending upon design parameters including the size of the cells 120.

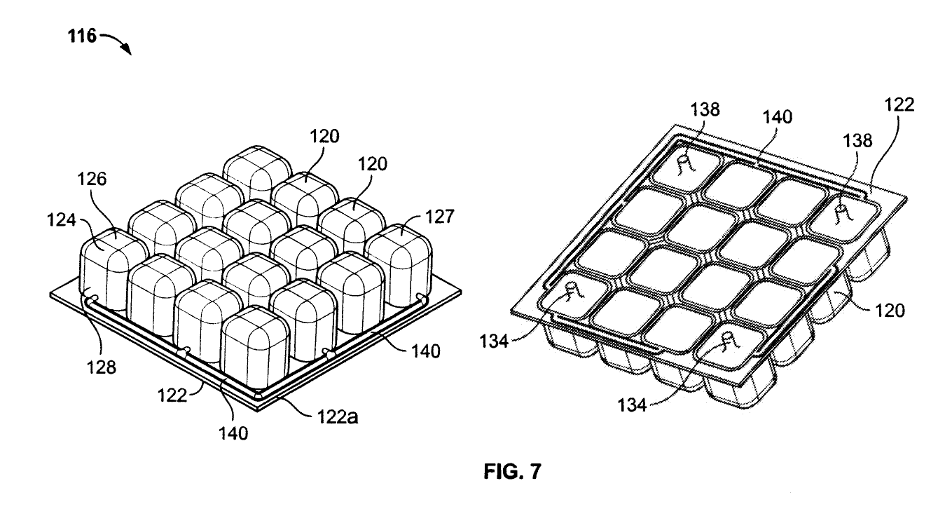

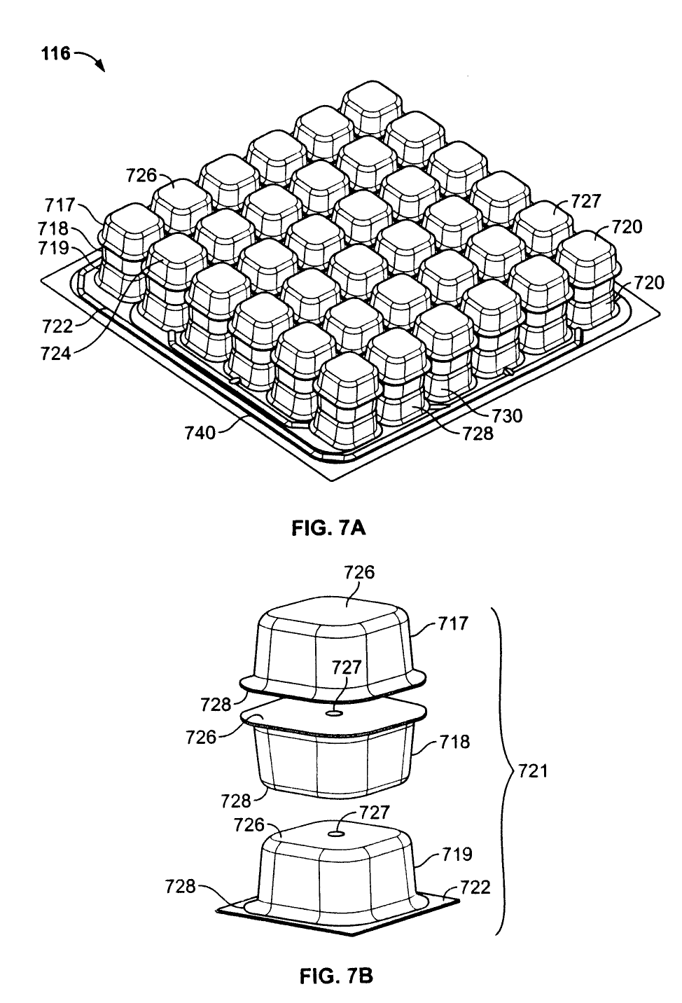

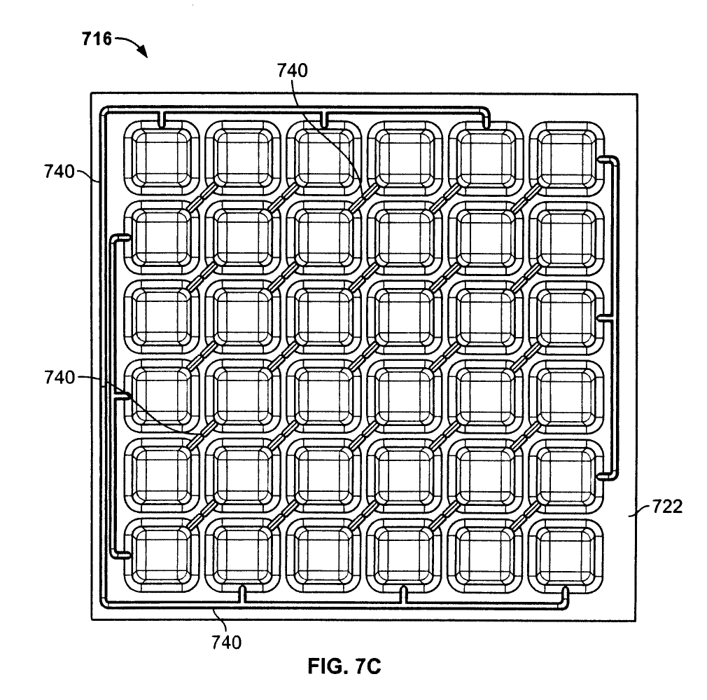

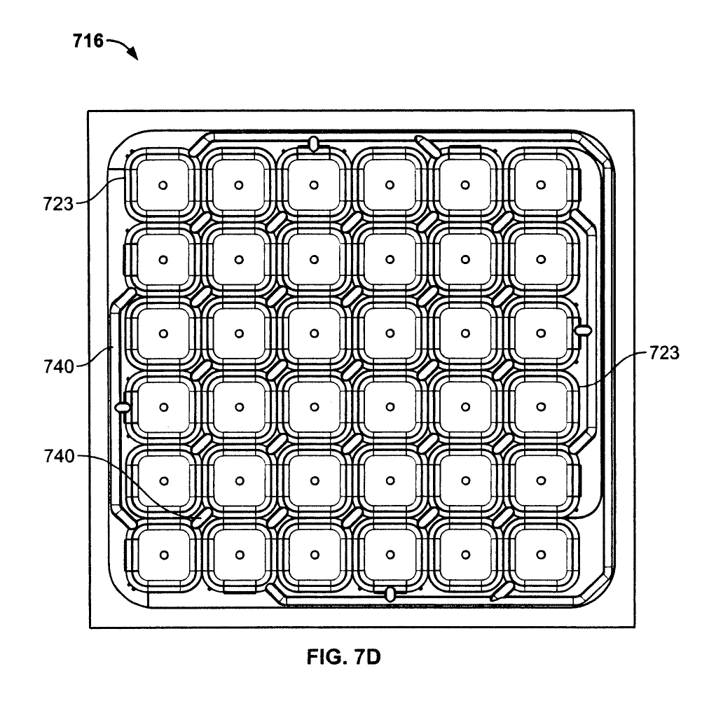

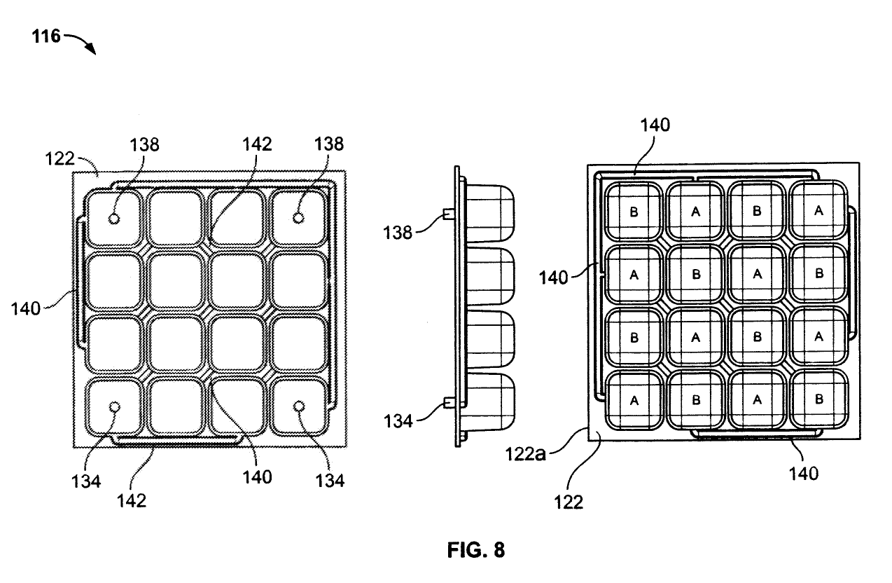

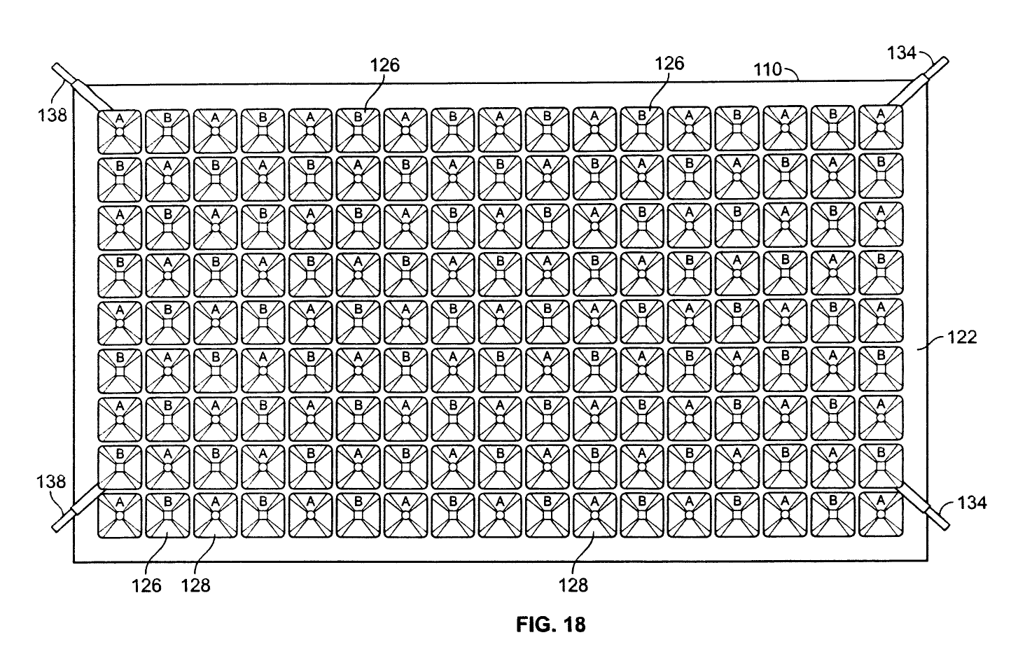

Referring to FIGS. 7, 8 and 18, various embodiments of an activation section 116 are disclosed. The activation section 116 is configured to apply a therapeutic movement of cells 120. In one embodiment this comprises alternating pressure in alternating chambers of the mattress. IN another embodiment this comprises applying a percussive and/or vibratory force, including to a patient's torso region, however, it may also be utilized in other areas of the patient support layer 110, such as the thoracic area. The activation section 116 has an array of cells 120 that are similar to that found in the head, torso and lower body sections 112, 114, 118. The top walls 126 of the cells 120 collectively define a support and engaging surface 127 of the activation section 116. In a preferred embodiment the cells 120 within the activation section 116 are separated into at least two groups—Group A and Group B—whereby alternating pressure, alternating percussion and/or vibration and/or a flotation force is applied to the patient on a per group basis. As shown in FIGS. 8 and 18, the cells 120 in Group A are in fluid communication with each other by a number of channels 140, and the cells 120 in Group B are in fluid communication with each other by a number of channels 142, but the cells in Group A are not in fluid communication with the cells in Group B. In a preferred embodiment, the channels 140, 142 connect to the lower portion 128 of each cell 120. As a result of the fluid communication, the Group A cells 120 define a first fluid passageway for the supply and distribution of air to the cells 120 within Group A. Similarly, the Group B cells 120 define a second fluid passageway for the supply and distribution of air to the cells 120 within Group B. Accordingly, air can be supplied and distributed to the groups as needed for percussion, vibration, alternating pressure or a flotation/static state. Due to the array of cells 120, in different embodiments both the Group A channels 140 and the Group B channels 142 may have internal and external segments, meaning some channel segments are within the cell array and some channel segments that are near the periphery of the base 122, however other orientations may be different. Some segments of the channels 140, 142 are directed along diagonals, while other segments are linear and are positioned along the periphery of the base 122.

The activation section 116 also includes an air supply fitting 134 for each channel 140, 142, whereby air can be selectively supplied and distributed through the fitting 134 to a group. In this manner, the blower assembly 310 or other supplier of air supplies air initially to a lead cell 120 and the air is distributed to the remaining cells 120 in the group via the channels 140, 142. The activation section 116 includes an exhaust or relief fitting 138 for each group that permits air to be exhausted through the alternating valve assembly 410 during the percussion and/or vibration modes. As explained in greater detail below, when the bed system 10 is in the percussion mode and/or vibration mode, in one embodiment the blower assembly 310 supplies air through the fitting 134 to cells 120 in both Groups A and B, however, air in Groups A and B is alternately exhausted through the fitting 138 in controlled manner by the valve assembly 410. While the blower assembly 310 constantly supplies air, the valve assembly 410 exhausts air in an alternating manner from cells 120 in one of the Groups A and B to provide the percussion and/or vibration desired by the operator. Alternately, in the alternating pressure mode the blower assembly 310 generally provides air to increase the pressure in one of the groups of cells 120 while air is exhausted from the other group of cells, and then alternates to provide air to the previously exhausted group of cells and exhaust air from the previously inflated group of cells 120. As shown in FIGS. 7 and 8, in one embodiment the activation section 116 has a four by four array of cells 120 providing a square configuration to the section 114, however, the configuration can be altered depending upon design parameters including the size of the cells 120 and the dimensions of the activation section 116. For example, as shown in FIG. 18 an alternating pressure activation section 116 may be a full size mattress. Although the activation section 116 is only shown as having the cell Groups A and B, other sections within the patient support layer 110 may be so configured.

The patient support layer 110 can include an alternate array of cells 720, wherein each cell 720 has an upper sub-cell member, a middle sub-cell member and a lower sub-cell member. Collectively the upper, middle and lower sub-cell members define a cell stack 721. The alternate array of cells 720 and the cell stack 721 can be utilized in any section of the patient support layer 110, including the head section 112, the torso section 114, the activation section 116 and/or the lower body section 118. FIGS. 7A-D provide an example of one embodiment of a cell stack 721 as depicted in an alternate activation section 716. As mentioned above, the cell stack 721 has an upper sub-cell member 717, a middle sub-cell member 718 and a lower sub-cell member 719, wherein the lower sub-cell 719 is joined to the base layer 722. It is understood that additional or less sub-cell members may be utilized without departing from the scope of the present invention. Of course, the cell stack 721 dimensions vary with the design of the sub-cell members 717, 718, 719. The sub-cell members 717, 718, 719 have a height of roughly 1.5 to 2.5 inches, causing the cell stack 721 to have an overall height ranging between 4.0 and 12.5 inches, however taller or shorter cell stacks may also be utilized. Generally, each sub-cell member 717, 718, 719 has an upper portion 724 and a top wall 726. In the upper sub-cell 717, the top wall 726 defines a patient support surface 727, that is the means of percussion and/or vibration and/or flotation for the patient. Therefore, the patient support system 110 does not require a percussion and/or vibration means separate from the cell stack 721. A lower portion 728 of each sub-cell member 717, 718, 719 has a side wall arrangement 730. The cells 720 and the cell stack 721 are made from thermoformed plastic or a similar material. As an example of the formation process, the sub-cell members 717, 718, 719 are individually thermoformed, joined together to form the stack 721 and then the stack 721 is connected to the base 722, such as via radio frequency welding. Additionally, the base 722 can be preformed with raised segments or channel segments therein.

As shown in FIG. 7B, the upper sub-cell member 717 is positioned over the middle sub-cell member 718, and the middle sub-cell member 718 is positioned over the bottom sub-cell member 719. The bottom sub-cell member 719 is sealed to the base layer 722 along the sealing line 723 (see FIG. 7D). Referring to FIG. 7B, in one embodiment each sub-cell member 717, 718, 719 has at least one orifice 727 that is operably connects that sub-cell to the adjoining sub-cell or sub-cells. The operable connection of the sub-cells 717, 718, 719 via the orifices 727 defines a fluid passageway for the transmission of air from the lower sub-cell 719 through the middle sub-cell 718 to top sub-cell 717. The top sub-cell 717 contains at least one orifice 727 (not shown in FIG. 7B) in a bottom wall 728 of the cell 720. Each middle sub-cell 718 has a top wall 726 with an orifice 727 that is aligned with the orifice 727 in the top sub-cell 717 to define one segment of the cell stack fluid passageway. Each middle sub-cell 718 has a bottom wall with an orifice 727 that is aligned with the orifice 727 in the bottom sub-cell 710 to define the remaining segment of the cell stack fluid passageway. As mentioned above, the passageway allows air to be transmitted between the sub-cells 717, 718, 719 of the cell stack 721.

In another embodiment of the cell stack 721, the middle sub-cell 718 is replaced by at least one tube (not shown) in fluid communication with the orifices 727 in the top sub-cell 717 and the lower sub-cell 719. Therefore, the tube facilitates the exchange of air between the top and bottom sub-cells 717, 719. In yet another version of the cell stack 721, the sub-cells 717, 718, 719 lack the orifice 727 and instead have a breathable fabric layer that allows for the passage of air between two or more sub-cells.

Similar to the cells 120 in the embodiment of the activation section described above, the cell stacks 721 within the activation section 716 are separated into at least two groups—Group A and Group B—whereby alternating pressure, percussion and/or vibration force, alternating pressure and/or flotation force is applied to the patient on a per group basis. As shown in FIGS. 7C and D, the cell stacks 721 in Group A are in fluid communication with each other by a number of channels 740, and the cell stacks 721 in Group B are in fluid communication with each other by a number of channels 742, but the cells in Group A are not in fluid communication with the cells in Group B. The channels 740, 742 generally connect to the lower sub-cell 719 of each cell stack 721 within the group. As a result of the fluid communication, the Group A cell stacks 721 define a first fluid passageway for the supply and distribution of air to the sub-cells 717, 718, 719 within Group A. Similarly, the Group B cell stacks 721 define a second fluid passageway for the supply and distribution of air to the sub-cells 717, 718, 719 within Group B. Accordingly, air can be supplied and distributed to the groups as needed for alternating pressure, percussion, vibration, or a flotation/static state. In general, air is supplied from the channel 740 though the lower sub-cell 719 and the middle sub-cell 718 to the upper sub-cell 717.

As shown in FIG. 2, in one embodiment a plenum layer 210 is utilized. In such an embodiment the plenum layer 210 is generally positioned below the patient support layer 110. In alternate embodiments the plenum layer is not utilized and the cells of the patient support layer are plumbed directly from the blower. The plenum layer 210 has a bladder assembly 211 with a first air bladder 212 that distributes air to and receives air from the head section 112, a second air bladder 214 that distributes air to and receives air from the torso section 114, and a third air bladder 216 that distributes air to and receives air from the lower body section 116. The first air bladder 212 is operably connected to the second air bladder 214 by a seam, and the second air bladder 214 is operably connected to the third air bladder 216 by a similar seam, both seams providing rigidity for the plenum layer 210.

The blower assembly 310 supplies air to the first air bladder 212 through a primary channel 220 that longitudinally extends through the second and third bladders 214, 216 and a collection of flexible supply lines 222. Air is distributed from the first air bladder 212 through a fitting 224 to the head section 112. The blower assembly 310 supplies air to the second air bladder 212 through a secondary channel 226 that longitudinally extends through the third bladder 216 and a collection of flexible supply lines 228. Air is distributed from the second air bladder 214 through a fitting 230 to the torso section 114. Instead of utilizing a channel 220, 226, the blower assembly 310 supplies air directly to the third air bladder 214 through a flexible supply line 232. Air is distributed from the third air bladder 216 through a fitting 234 to the lower body section 116. The primary and secondary channels 220, 226 can be welded by a drop-stitch technique to increase their strength and durability.

The blower assembly 310 supplies air to the activation section 116 through a pair of tubes 240, 242 that extend longitudinally along the third bladder 216 and an extent of the second bladder 214. Specifically, a first tube 240 supplies air from the blower assembly 310 through a fitting 244 to the Group A cells 120, and a second tube 242 supplies air from the blower assembly 310 through a fitting 244 to the Group B cells 120. In an another embodiment, the first and second tubes 240, 242 are replaced by a channel 220, 226 described above. A layer of foam may placed over the plenum layer, including the fittings, tubes and channels, to increase the patient comfort levels. The blower assembly 310 can include valve means, such as a one-way valve, to maintain a constant or static pressure in any of the bladders 212, 214, 261 and the activation section 216. It is understood, however, that any of the plenums may be eliminated or replaced with tubing directly from the blower/air supply to the cells.

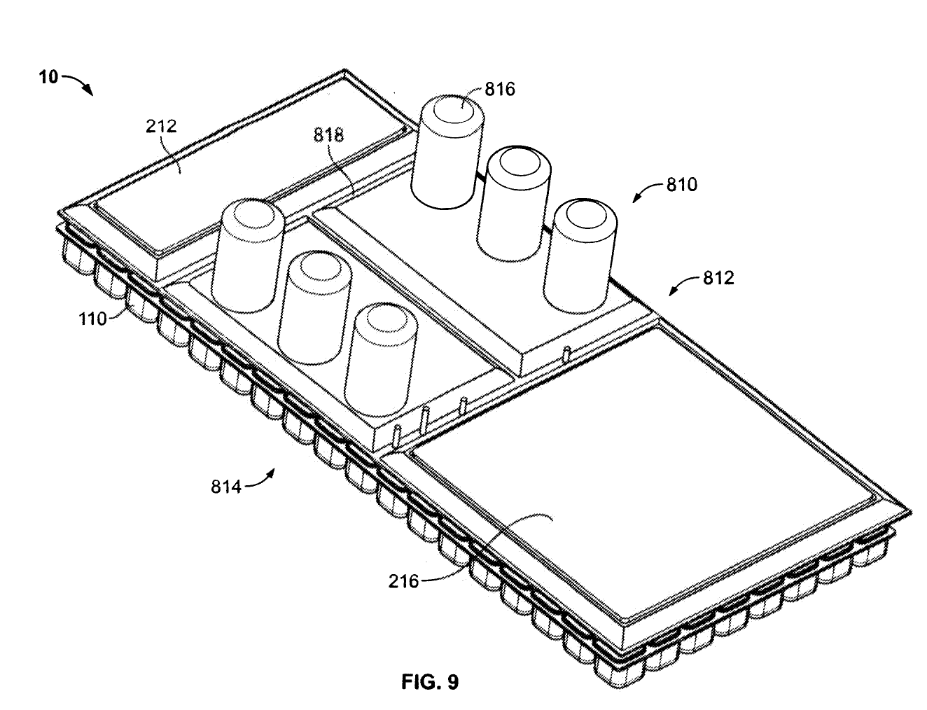

As shown in FIG. 9, the bed system 10 may also include a rotation assembly 810, typically having a left rotation element 812 and a right rotation element 814. In the embodiment reflected in FIG. 9, the rotation elements 812, 814 comprise a plurality of inflatable bladders, herein shown as posts 816. In one embodiment the rotation assembly 810 is positioned between the first air bladder 212 and the third air bladder 216 in the plenum layer 210. A central seam 818 bisects the elements 812, 814 to aid with the rotational operation of the assembly 810. A chord extending through the center of each group of posts 816 is parallel to the seam 818. Alternatively, a single bladder 816 may be utilized for each rotation element 812, 814, wherein the bladder 816 is placed on its side and it longitudinal axis is parallel to the seam 818. Preferably, the left and right rotation bladders are positioned below a lower surface of the torso section 114 whereby rotation is conducted on a per-side basis of the plenum layer 210. The left and right air elements 812, 814 can be a single inflatable bladder or multiple bladders each capable of having a variety of configurations, including rectangular, square, triangular, circular, etc. Similar to the first, second and third air bladders 212-216, the blower assembly 310 or some other supply of air supplies air to the left and right rotation bladders. In another embodiment, the left and right rotation bladders each comprise a number of smaller bladders that function as a rotation unit for rotation of each side portion of the patient support layer 110.

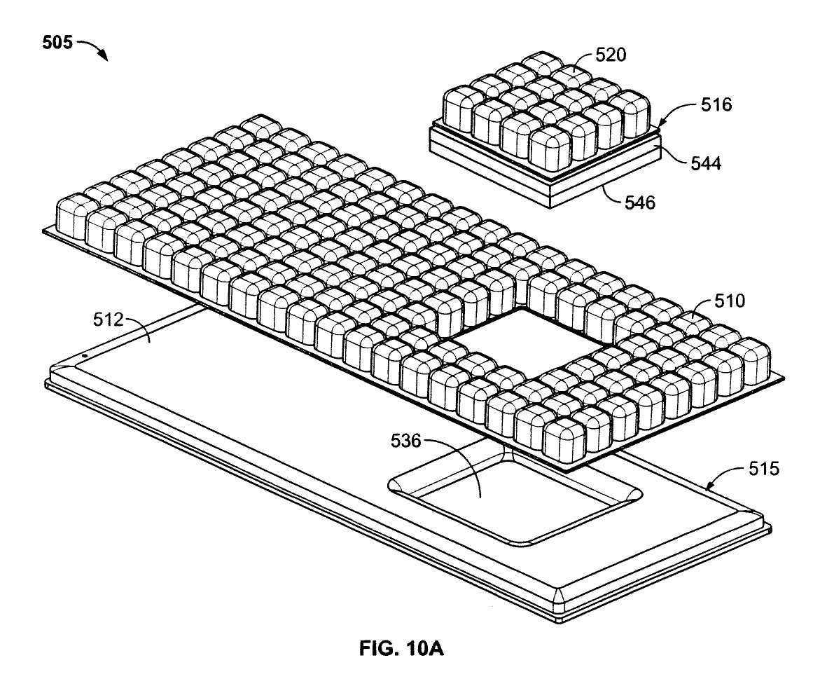

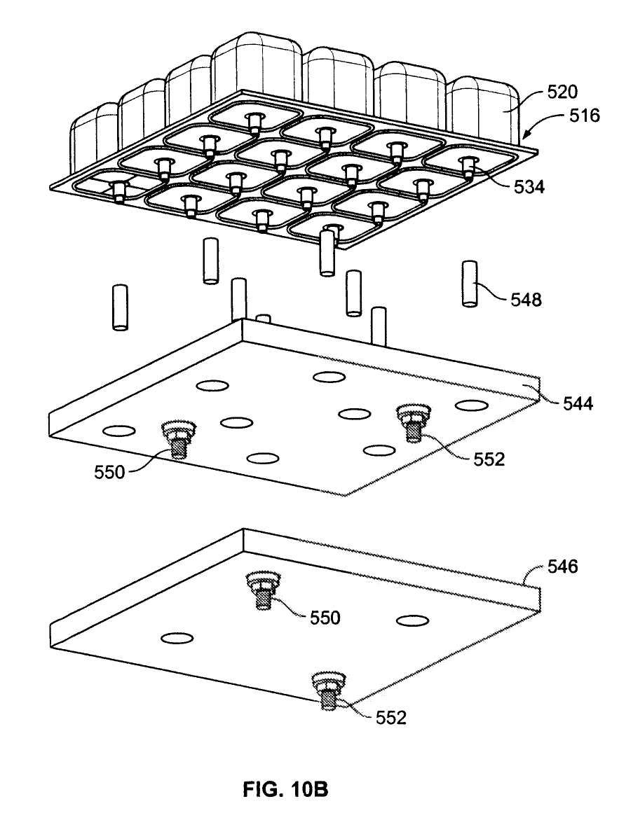

FIGS. 10A and 10B depict an alternate bed system 505, wherein the bed system 505 includes an activation section 516 operably connected to a pair of chambers 544, 546. Instead of distinct multiple bladders, the plenum layer 515 has a single bladder 512 with an opening 536 to receive the chambers 544, 546. The activation section 516 includes an array of cells 520 wherein each cell 520 has a depending fitting 534 for fluid connection with one of the chambers 544, 546. The activation section also includes Group A and Group B cells. The Group A cells 520 are in fluid communication with the chamber 544 through the fittings 534. The chamber 544 has a supply fitting 550 for the supply of air from the blower assembly 310 and an exhaust fitting 552 for the discharge of air from the chamber. The Group B cells 520, through the fittings 534 and an extension piece 548, are in fluid communication with the chamber 546. Like the chamber 544, the chamber 546 has a supply fitting 550 for the supply of air from the blower assembly 310 and an exhaust fitting 552 for the discharge of air from the chamber. Therefore, the chambers 544, 546 act as smaller plenums for the supply and/or exhaust of air from Group A and B in the activation section 516. When the activation section 516 and the chambers 544, 546 are in an assembled position, the chamber 544 for Group A is positioned between the activation section 516 and the chamber 546 for Group B.

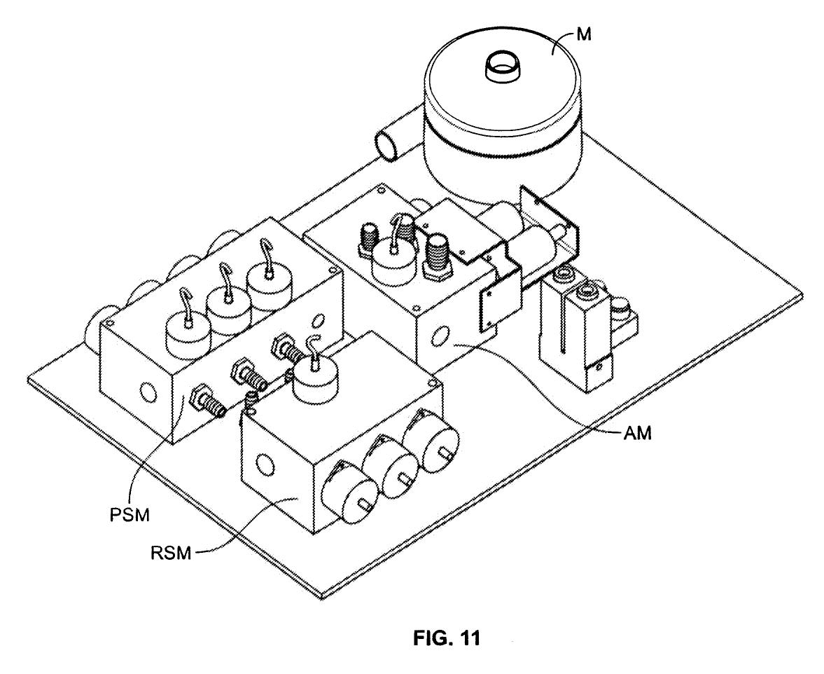

As shown in FIG. 11, one embodiment of a blower assembly 310 for an embodiment of the bed system 10 includes a number of components to supply air to the patient support layer 110 and/or the plenum layer 210. These components include a blower or pump, a number of control valves and manifolds, a power supply (typically supplying 120 VAC), pressure transducers and other components associated with the air supply and zone controls. Preferably, the blower assembly 310 is mounted to the standard bed frame or support structure without modification. The actual blower can be sized to provide a sufficient amount of air to the support layer 110 for a patient weighing up to 1,000 pounds. As explained above, the blower may be an appropriately sized pump. The blower assembly 310 is configured to communicate with a combined control panel and user interface (not shown) such that an operator can control the operation of the blower assembly 310 and the settings of the bed system 10. Depending upon the settings entered by the operator in a control panel or other control member, the blower assembly 310 can supply air on a substantially constant basis to the plenum layer 210 and the patient support layer 110 through passageways, such as supply lines 222, 228, 232 and the tubes 240, 242. While the blower assembly 310 supplies air to the plenum and support layers 110, 210, the activation valve assembly 410 controls the quantity of air exiting the activation section 116. The blower assembly 310 can be mounted to any portion of the bed frame or the support frame for the bed assembly. Alternately, the blower assembly 310 can be utilized without an activation valve assembly 410 and monitor and supply or exhaust air as needed from each group of cells as required by the specific therapy. For example, in an alternating pressure therapy the blower assembly 310 may supply from approximately 20 mm. Hg. to approximately 32 mm. Hg. in the pressurized group of cells 120 and may entirely exhaust the air pressure in the other group of cells 120.

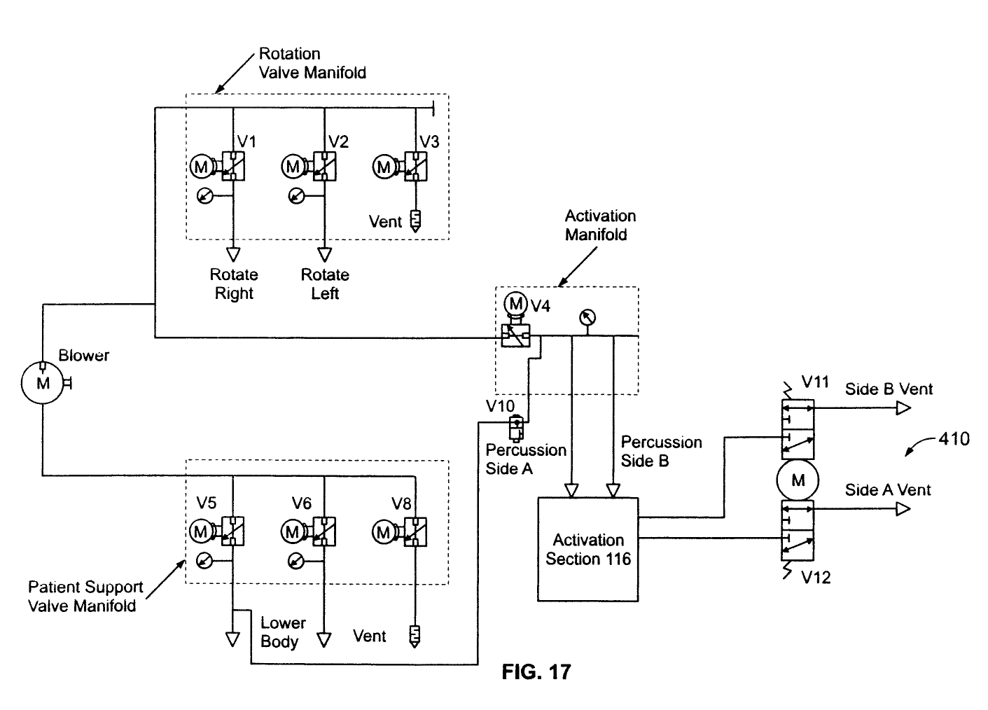

Referring to the schematic of FIG. 17, in one embodiment, the blower assembly 310 includes a valve assembly 312 with a number of valves and at least one manifold. In general terms, in one assembly the blower assembly 310 includes the blower M; a rotation valve manifold RVM having left and right rotation valves V1, V2 and a vent valve V3; a patient support manifold PSM having a valve V5 for the head and torso sections 112, 114, a valve V6 for the lower body section 118 and a vent valve V8; and, an activation manifold AM having a flow control valve V4 and a torso to percussion/vibration crossover valve V10. The valves V4 and V10 are operably linked with the activation section 116 for alternating pressure, percussion and/or vibration. The precise number and type of valves varies with the design parameters of the bed system 10, including the patient support layer 110, the activation section 116, and the plenum layer 210. The schematic also includes the activation valve assembly 410 that is operably connected to the activation section 116 to control the exhaust of air from Group A and Group B cells 120 in the activation section 116. It is understood that other types of blowers/valves may be utilized to perform the functions described herein.

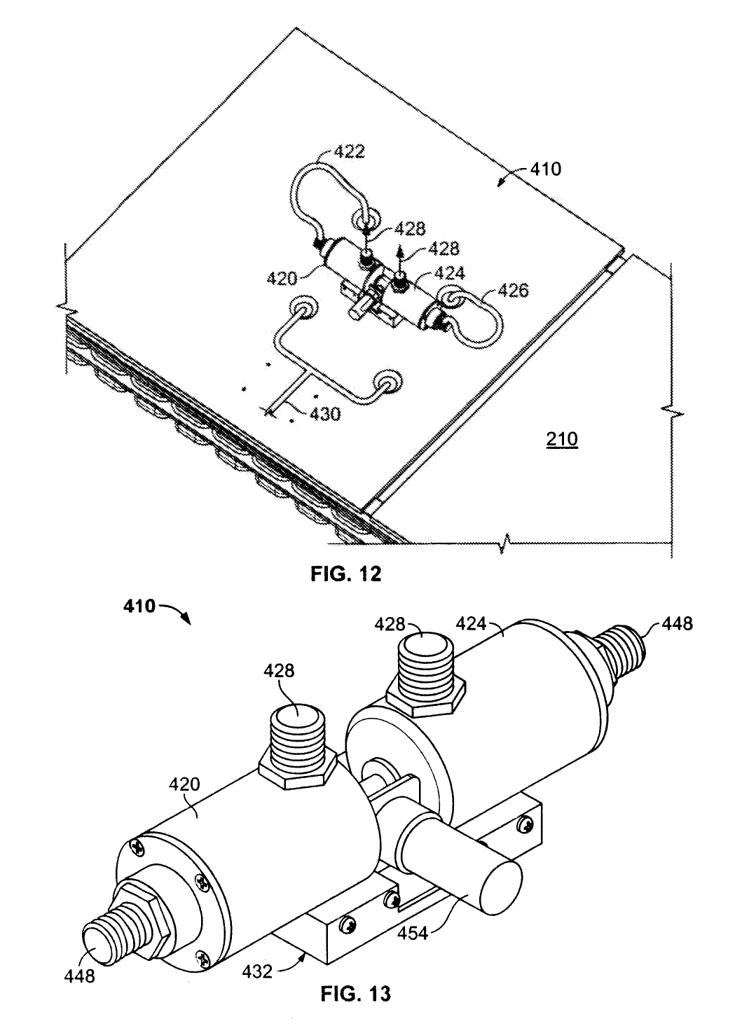

As explained above, in one embodiment of the blower assembly 310 an activation valve assembly 410 is utilized. The activation valve assembly 410 shown in FIGS. 12-16 is configured to control the quantity of air discharged or exiting the cells 120 of Groups A and B in the activation section 116. In one embodiment, the valve assembly 410 includes a first valve 420 and a second valve 424 in opposed positional relationship. The first valve 420 is in fluid communication with the Group A exhaust fitting 138 by a flexible line 422, and the second valve 424 of the assembly 410 is in fluid communication with the Group B exhaust fitting 138 by a flexible line 422. Each valve 420, 424 has a vent 428 configured to release or vent air discharged from the Group A and B cells 120 in a controlled manner to ambient. Described in a different manner, the valve assembly 420 controls the quantity and pressure of air in Groups A and B for treatment purposes, including alternating pressure, percussion and vibration treatment.

Referring to FIG. 12, in one embodiment the valve assembly 410 is mounted to a lower surface of the plenum layer 210. The plenum layer 210 can include a substantially rigid support base and the valve assembly 410 can be mounted thereto. The lines 430 represent air supply lines to the activation section 116, namely Groups A and B. Referring to the schematic of FIG. 17, the valve assembly 410 controls the discharge of air from the activation section 116 while the blower assembly 310 supplies air to the activation section 116. The valve V11 in the schematic corresponds to the valve 420 and the valve V12 corresponds to the valve 424.

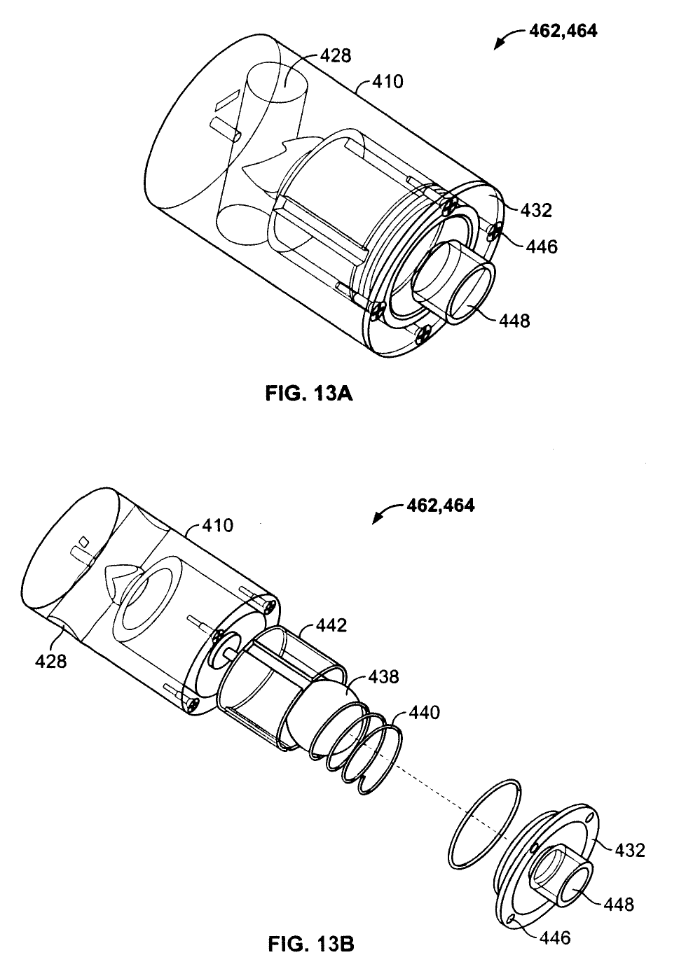

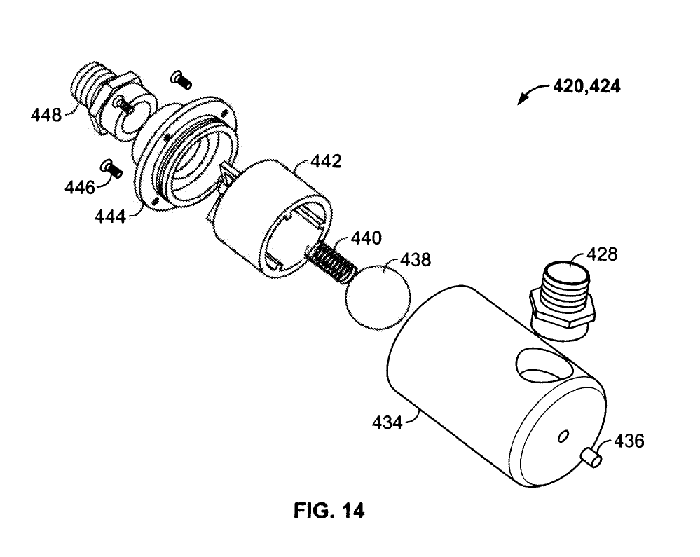

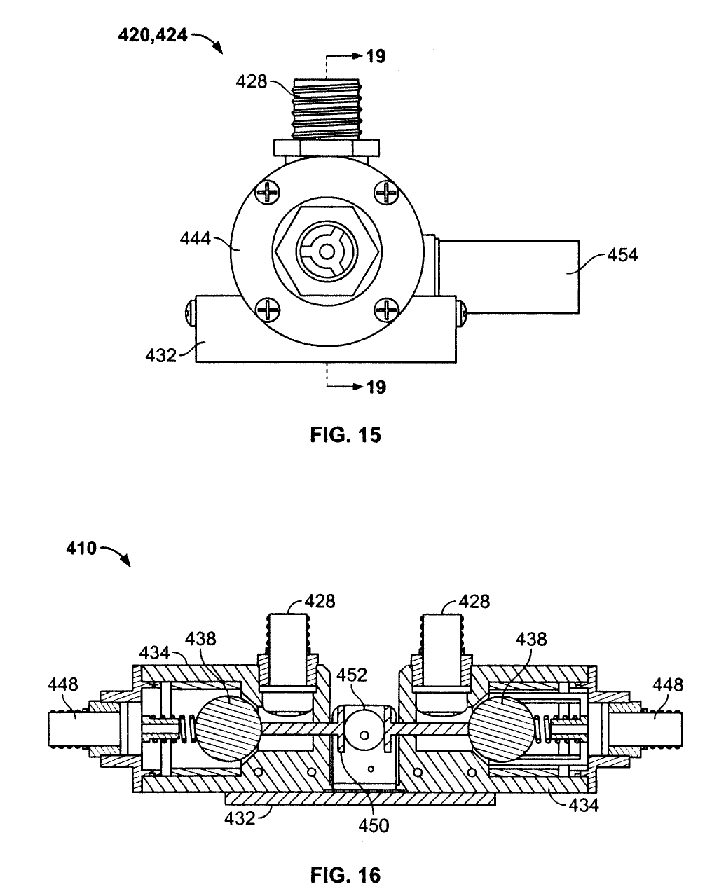

As shown in the embodiment FIG. 13, the valve assembly 410 includes two distinct valves 420, 424 that are affixed to a mounting plate 432. Referring to FIG. 14, the valves 420, 424 have a similar construction wherein each valve 420, 424 includes: a vent fitting 428, a valve body 434, a bearing 436, a ball valve 438, a spring 440, and a guide 442. The valve 420, 424 further includes a cap 444 and fasteners 446 to secure the cap 444 and secure the valve body 434. Inlet fitting 448 is in fluid communication with flexible lines 422, 426 which distribute air from cells 120 of Groups A and B to the valve assembly 410. Specifically, exhausted air from Group A is supplied to valve 420 via the flexible line 422, while exhausted air from Group B is supplied to valve 424 via the flexible line 426. Therefore, there is preferably a 1:1 relationship between a group and a valve 420, 424. As shown in FIGS. 15 and 16, each valve 420, 424 has a plunger 450, wherein the plungers 450 are positioned on opposite sides of a cam 452, preferably an eccentric cam.

The alternating valve assembly 410 has been described above as having opposed valves 420, 424 wherein there is a 1:1 relationship between the valves 420, 424 and Groups A, B. In another embodiment, the valves 420, 424 are configured in a different positional relationship whereby air is exhausted from the cells 120 of Groups A and B in a similar manner as described above. For example, the valves 420, 424 can be distinct valves operated independently. In such an embodiment, one valve could be providing for vibration therapy in one of the activation cell groups, and the other valve could be providing for percussion therapy in the other activation cell groups. Alternatively, one of the valves could be providing alternating pressure, and flotation/static therapy. Similarly, the valves could be set for varying timing of the different therapies provided. Accordingly, it is understood that an unlimited variety of therapy and therapy timing combinations are possible with multiple independent valves for each activation cell group. In yet another embodiment, the valve assembly 410 includes a single valve 420 that is operably connected to Groups A and B, whereby the single valve 420 receives and exhausts air from cells 120 in both Group A and Group B. Further, it is understood that any valve assembly can be positioned within the blower box 310.

FIGS. 13A and 13B show yet another alternative valve 462, 464 which can be used in the activation valve assembly 410. The alternative valve 462, 464 includes an inlet 448 which is connected to a plate 432. The plate 432 is connected with fasteners 446 to one end of a cylindrically shaped body of the activation valve assembly. Near the opposite end, the body contains an exhaust shaft 428 which extends through the entire body of the activation valve assembly 410. The body of the activation valve assembly 410 houses a guide 442 which surrounds a ball valve 438 and a spring 440. An O-ring is situated between the interior of the plate 432 and the spring 440.

In this embodiment air is supplied from Groups A and B in the activation section 116, or any other portion of the mattress, to one of the valves 420, 424 through the inlet fitting 448. A variable speed motor (not shown) typically drives the cam 452 which, through the plunger 450, unseats one of the balls 438 in an alternating manner, however, it is understood that other drive means, such as actuators or solenoids, may be utilized without departing from the scope of the present invention. The motor is connected to the cam 452 by coupling shaft 454. The unseating of the ball 438 and the attendant compression of the spring 440 allows air within the valve body 434 to flow past the ball 438 and to the outlet fitting 428 for discharge from the valve 420, 424. Once the motor has moved the cam 452 to its smallest position, the plunger 450 moves towards the cam 452 and the spring 440 re-seats the ball 438 to prevent air from reaching the outlet fitting 428. By varying the speed of the motor, the frequency of the valve 420, 424 opening and closing and the resultant discharge of air through the outlet fitting 428 can be increased or decreased. Due to the opposed configuration of the valves 420, 424, the valve assembly 410 alternates between venting the air from either Group A or Group B thereby causing the cells 120 in the other group to remain pressurized and exert a force on the patient. In this manner, the valve assembly 410 provides alternating cell group force application to a patient's thoracic region. As explained below in the operations section, the frequency at which the valve assembly 410 alternates determines whether alternating pressure, percussion or vibration is applied.

The therapy bed system 10 has several modes of operation, including standard, high pressure, alternating pressure, pulsation, percussion, vibration, rotation, flotation, wound therapy and any combination thereof. For example, the bed system 10 may include a combination of percussion and vibration, or a combination of rotation, percussion and vibration, etc. As another example, the bed system 10 can be placed in a high pressure state for emergency treatment of the patient, such as CPR. Additionally, the bed system 10 may be utilized for alternating pressure therapy. The precise number of operational modes is dependent upon the configuration of the bed system 10 and the end-users desired operating parameters.

In the standard mode, the blower assembly 310 supplies air to each of the head section 112, the torso section 114, the activation section 116 and the lower body section 118, while the activation valve assembly 410 is closed to retain generally constant air pressure with the sections 112-118. The air pressure level can be a default level or a level entered by an operator. In another version of the standard mode, different sections 112-118 can be maintained at different pressures. For example, the head and torso sections 112, 114 can be maintained at a first pressure while the lower body section 118 can be maintained at a second pressure. In this mode, the cells 120 and the support surface 127 acts as a local pressure reduction surface because the interconnecting cells 120 will self compensate or adjust to patient position to evenly distribute weight applied to the support surface 127.

In contrast to the standard mode, the percussion mode is a dynamic mode. While the blower assembly 310 supplies air to the cells 120 in Groups A and B of the activation section 116, the activation valve assembly 410 exhausts air in an alternating manner from Groups A and B thereby affecting the pressure with the Groups. As an example, when air is exhausted from Group A by the valve assembly 410, the cells 120 in Group A generally deflate (thereby reducing their overall height), and the cells 120 in Group B remain pressurized to support the patient. The cells 120 in Group B may experience an increase in pressure that increases their overall height resulting in a force applied to the patient. The exhaustion of cells in Groups A and B alternate as the cam 452 and the plunger 450 are actuated during operation of the valve assembly 410. Therefore, the controlled exhaust of air provided by the valve assembly 410 enables the cells 120 within the Groups A and B to provide alternating force applications to the patient. In this manner, the cells 120 and the support surface 127 provide the means of treatment to the patient, not a separate element. Accordingly, when the valve assembly 410 closes for a certain group during a percussion therapy, for example, the group receives an almost instantaneous pressure increase, thereby causing those cells in the group to “pop” as may be required by a given therapy regimen. The force application results a dynamic system with pneumatically powered cell groups where the pressure therein is actively adjusted by the valve assembly 410 and the control panel.

Depending upon the frequency of operation of the valve assembly 410 and the resulting air exhaustion, the applied force can be a pulsation force, a percussive force, a vibration force, a flotation/static force or a combination thereof. The percussive forces are intended to be roughly equivalent to a procedure that a nurse would perform on a patient to break loose phlegm from the walls of the lungs by cupping the hands and beating on the back in the lung area. The frequency resulting in a percussive force is roughly one to five beats or cycles per second. The manifold air pressure of the activation section 116 is roughly 46-56 mm Hg (25-30 inches of water), whereas during percussion or vibration the maximum pressure in the head, torso and lower body sections 112, 114, 118 is roughly 9-37 mm Hg (5-20 inches of water).

The blower assembly 310, the activation section 116 and the activation valve assembly 410 operate in a similar manner to provide the vibration mode. Thus, the valve assembly 410 exhausts air in an alternating manner from Groups A and B to provide the applied force explained. In contrast to percussion, the frequency resulting in a vibratory force is roughly 6-25 beats or cycles per second. The goal of the vibration mode is to move the phlegm that has been loosened by the percussion action so that it can be expectorated. As explained above, vibration and percussion can be combined in one treatment application to obtain the benefits of both therapies.

In the rotation mode, the patient is slowly rotated from side to side to facilitate the movement of fluid in the lungs so that it can be expectorated. The typical range of rotation is roughly 5 degrees to 60 degrees. Rotation occurs through the inflation and deflation of the bladders located beneath the torso section 114. Rotation can be used in conjunction with percussion and/or vibration to achieve greater fluid removal from the patient.

As identified herein, the therapeutic bed system 10 may be utilized for alternating pressure. In the alternating pressure mode the alternating cell 120 portion of the mattress may be the full size of the bed, or alternating cell activation sections 116 may be provided in a mattress made of additional cells 120 or of non-inflatable components, such as foam or gel. Additionally, the mattress 110 may be placed in a foam frame, may have a foam base member, and may be wrapped in a mattress cover for use on a hospital bed as described in related U.S. patent application Ser. No. 11/349,683. Typically, the cells 120 comprise a plurality of inflatable components such as soft, fluidly interconnected but independently movable, air-filled cells 120 which are grouped in groupings as described above. In a preferred embodiment two groupings of cells 120, Group A and Group B, are utilized, however it is understood that additional groupings of cells may be utilized with the alternating pressure mattress. In the alternating pressure mode, pressure is alternated between the cells of group A and the cells of group B. Further, the pressurized cells 120 of each group are able to redistribute air pressure between each of the cells 120 in the group to allow the cells 120 of the mattress 1200 to conform to the contours of a patient's body with minimal tissue deformation to provide a friction and shear relief surface. Rather than being non-powered, in the alternating pressure air mattress the cells 120 are provided in an open system in connection with a pump or blower assembly 310, preferably plumbed directly to the chambers of the air mattress.

The air cells 120 of the alternating pressure mattress 110 are generally arranged in an array of rows and columns. In a preferred embodiment the air cells 120 are elongated vertically and extend from the generally flexible base 122, in a tower-like configuration. The cross-sectional shape of the cells 120 may be square, rectangular, round or any other design that provides the proper qualities to the mattress 110. In a preferred embodiment, the inflatable components 60 are made of a durable neoprene rubber that is flame-resistant and can be easily cleaned. Additionally, in a preferred embodiment the air cells 120 extend approximately 3.5″ from the base 122, however, in an alternate embodiment the cells 120 extend at least 2.5″ from the base 122. When the mattress 110 is used alone on a bed the cells may have a height from 2.5″ up to and including 10″, however a typically mattress will have cells that are between 2.5″ and 6.0″. In another embodiment the air cells 120 are approximately 4.0″ in height. Each of the cells 120 has a sidewall 128 and a top portion 126 defining a patient support surface 127. Further, each cell 120 has an interior cavity defined by the interior of the sidewall 128, the top portion 126 and the base 122. The cavities of the cells 120 of Group A, also referred to as the first group, are fluidly interconnected together to define a first group chamber, and the cavities of the cells 120 of Group B, also referred to as the second group, are fluidly interconnected together to define a second group chamber, with the first group chamber not being fluidly interconnected to the second group chamber. In one therapy the first group of cells has a volume of air and the other group of cells has a reduced volume of air.

The first group of cells 120 has an inlet port 134 and an exit port 138 to allow air to be injected into the first group of cells 120 at the inlet port 134 and to allow at least a portion of the air in the first group of cells 120 to be exhausted at the exit port 138 as appropriate for the alternating pressure therapy. Similarly, the second group of cells 120 has an inlet port 134 and an exit port to 138 to allow air to be injected into the second group of cells 120 at the inlet port 134 and to allow at least a portion of the air in the second group of cells 120 to be exhausted at the exit port 138 as appropriate for the alternating pressure therapy. The blower or pump 310 is in fluid communication with the inlet and outlet ports 134, 138 of the mattress 110 and supplies air pressure to the cells 120 as appropriate in the mattress 110. Alternatively, each of the group of cells 120 may have only an inlet port 134 and air may be able to be injected and exhausted from the same port 134 without requiring a separate exit port 138. In such an embodiment, the blower or pump 310 is in fluid communication with each of the inlet ports 134 and can supply and exhaust air therefrom.

As shown in FIG. 18, the cells 120 of the first group (i.e., the “A” cells) alternate across the mattress 110 with the cells 120 of the second group (i.e., the “B” cells), and preferably they alternate diagonally across the mattress 110. Referring to the FIG. 18, in a preferred embodiment the mattress 110 has a plurality of adjacent and opposing edges 131a-d. The cells 120 of the first group extend in a plurality of diagonal groupings from one edge of the mattress 110 to an adjacent edge of the mattress 110, and the cells of the second group also extend in a plurality of diagonal groupings from one edge of the mattress 110 to an adjacent edge of the mattress 100 depending on the size and configuration of the mattress 110. It is possible, however, depending on the configuration of the mattress that the cells may extend to an opposing edge of the mattress.

In a preferred embodiment, the alternating pressure mattress 110 operates with each group of cells 120 having independent equilibrium flotation capabilities with constant restoring forces. Accordingly, the individual cells 120 are adapted to move independently in at least six degrees of freedom, including both directions in the z-axis (i.e., up and down), both directions in the x-axis (i.e., side to side) and both directions in the y-axis (i.e., front to back). Further, in certain embodiments the individual cells 120 can twist, turn and bend to adapt to the contours and anatomy of the patient thereon. Further, when the patient is provided on the mattress 110 the patient is partially immersed in the cells. With such immersion the forces and pressures pushing back on the patient are kept equal at all times. More specifically, because each of the cells 120 in a group are fluidly interconnected, greater contact area is achieved for dispersion of pressure on the entire body and the forces and pressures pushing back on the patient on the mattress are kept substantially equal at all points on the patient. Thus, the pressure on any one areas of the body of a patient on the alternating pressure mattress 110 is minimized.

In an alternative therapeutic operation, all of the cells 120 of the mattress 110 may be inflated and deflated simultaneously, and typically cyclically, to raise and lower a patient thereon.

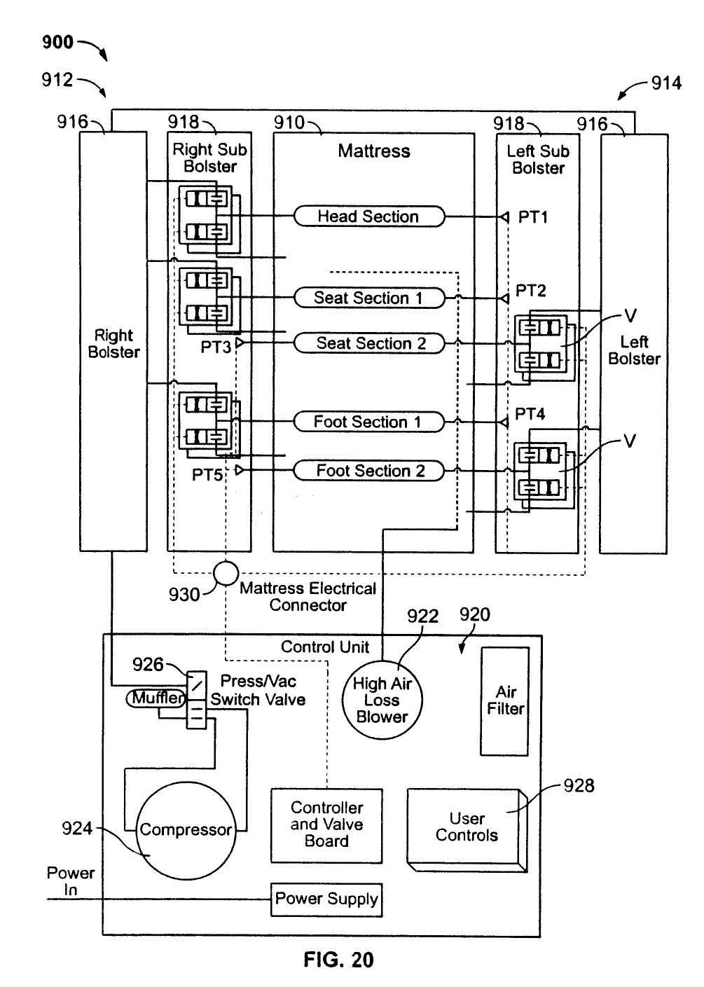

FIG. 20 provides a block diagram of another alternate mattress system 900, wherein the mattress provides therapeutic treatment to a patient. In this system 900, a mattress assembly 905 having and external cover encasing a mattress 910, a right bolster assembly 912 and a left bolster assembly 914, wherein each bolster assembly 912, 914 comprises a bolster 916 and a sub-bolster 918. Preferably, the bolster 916 of each bolster assembly is positioned above its respective sub-bolster 918. The overall height of the bolster assembly 912, 914 generally corresponds to that of the mattress 910, however alternate embodiments may be provided that are taller or shorter than the adjacent mattress 910. The system 900 further includes a control unit 920, that as explained below, is operably connected to the mattress 910 and the bolster assemblies 912, 914. Additionally, a controller (not shown) is typically electrically connected to the control unit 920. Although no alternating pressure, percussion or vibration elements are shown in the block diagram of FIG. 20, it is understood that both could be provided with the system 900 in a manner consistent with this disclosure.

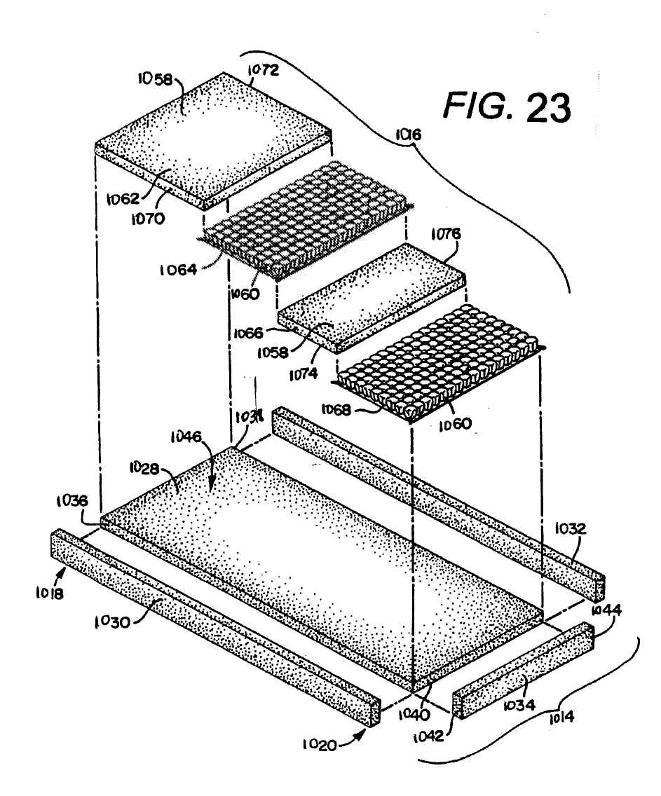

In this embodiment the mattress assembly 905 has an external cover that encases the mattress 910 and bolster assemblies 912, 914. Accordingly, the external cover defines a cavity around the mattress 910. In one embodiment, the mattress 910 has a head section, a plurality of seat sections, and a plurality of lower body or foot sections. A high air loss blower 922 within the control unit 920 supplies air to the cavity at the rate of roughly 5-10 cubic feet per minute. In another embodiment, the blower 922 supplies air to the cells 120 for percussion and/or vibration treatment. Air is supplied through at least one line to the bolsters 916 by a compressor 924 located in the control unit 920. In the embodiment shown in FIG. 23, air is supplied from the bolster 916 through the valve V in the respective sub-bolster 918 and then to the cells 120 in the particular section of the mattress 910. The bolsters 916 may operate as bladders having a measurable internal volume which allows for the bolster 916 to act as a storage plenum for air supplied by the control unit 920. The sub-bolsters 918 are a generally semi-rigid structure, such as foam, with internal cavities to accommodate a plurality of pressure transducers PT and one-way valves V. When the valves are in a closed position, the cells 120 in the mattress 910 maintain a constant or static pressure whereby the patient undergoes floatation support or therapy. In another design configuration, the valves V are moved from the sub-bolsters 918 to the control unit 920 or within a lower portion of the mattress 910.

As mentioned above, the control unit 920 contains the high air loss blower 922 which provides air to the cavity within the enclosure 905, and the compressor 924 which supplies air to the bolsters 916 and mattress sections. A combination pressure/vacuum switch valve 926 is positioned between the compressor 922 and the bolsters 916, which allows for air to be drawn out of the bolsters 916 in a vacuum mode. The control unit 920 further includes a power supply, a combined controller and valve board, a muffler, and an air filter. A user control interface 928 may be mounted to the control unit 920 or remotely connected to the unit 920. A electrical connector 930 is electrically positioned between the control unit 920 and the pressure transducers PT and the valves V within the sub-bolsters 918. The control unit 920 can be secured to any portion of the bed frame or support structure, including under the mattress 910. The user control interface 928 can be operably mounted in a similar manner, including to one of the bolster assemblies 912, 914.

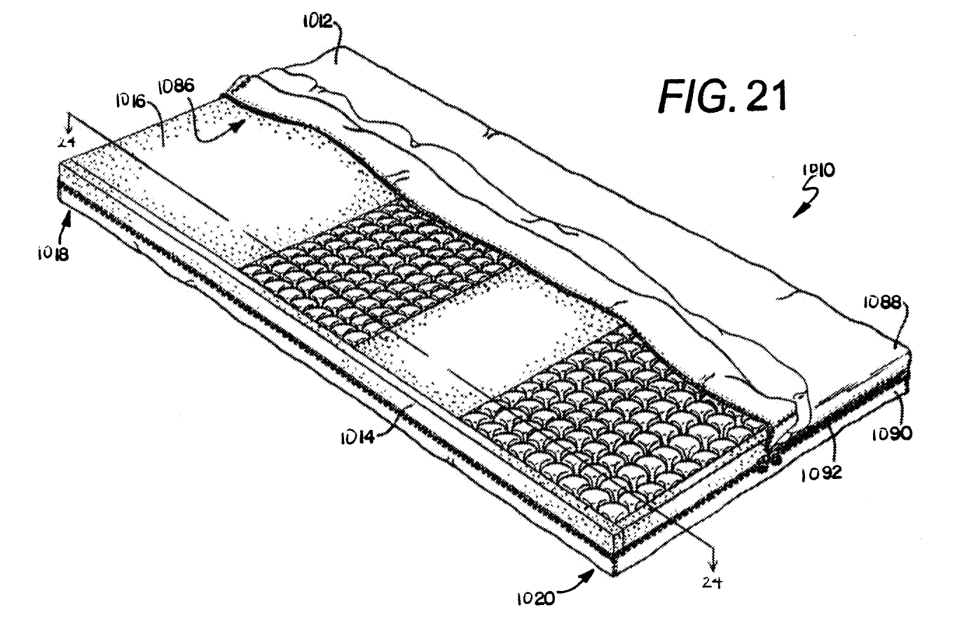

Referring to FIGS. 21-31, there are shown various embodiments of another therapeutic mattress 1010. The therapeutic mattress 1010 generally comprises a covering or encasing 1012 housing a first or base layer 1014 and a patient support layer 1016. Often, patients confined to a bed for a long period of time frequently develop pressure sores, which can be known as decubitus ulcers or the more commonly referred to bedsores. The various embodiments of the therapeutic mattress 1010 described herein assist in preventing or decreasing the potential for such bedsores for some patients, in conjunction with proper care and nutrition.

As shown in the Figures, the therapeutic mattress 1010 has a head end 1018 and a foot end 1020 opposing the head end 1018, a first side 1022 and a second side 1024 opposing the first side 1022. The term “head end” is used to denote the end of any referred to object that is positioned to lie nearest the head end 1018 of the mattress 1010, and the term “foot end” is used to denote the end of any referred to object that is positioned to lie nearest the foot end 1020 of the mattress 1010. Generally, the therapeutic mattress 1010 provides components for the various sections of the base layer 1014 and patient support layer 1016 of the mattress 1010 that have varying levels of pressure relief and deflection as measured in units of either indentation load deflection (ILD) or pressure.

In one embodiment, the base layer 1014 of the mattress 1010 comprises a bottom member 1028. In alternate embodiments the base layer 1014 also comprises a perimetral frame 1015. The perimetral frame 1015 provides support and shape to the mattress 1010 and generally contains the patient support layer 1016 within a defined boundary. In one embodiment, the perimetral frame 1015 comprises first and second opposing transverse side panels or members 1030, 1032. In another embodiment the perimetral frame 1015 also comprises a first end member 1034. It is understood that in alternate embodiments, as discussed herein, a second end member opposing the first end member 1034 may be provided to provide a perimetral frame 1015 that traverses about the entire perimeter of the mattress 1010 interior of the encasing 1012.

The bottom member 1038 is preferably made of a high density, high resilient, low compression open cell urethane foam that is fire retardant and is set for medical bedding. In one embodiment the bottom member 1028 is approximately 3″ thick and has an ILD value of generally greater than 1030, and preferably 1040. The bottom member 1028 in the embodiment shown extends generally from the head end 1018 to the foot end 1020 of the mattress 1010, and generally from the first side 1022 to the second side 1024 of the mattress 1010. In alternate embodiments the bottom member 1038 may be much thinner, allowing for a thicker patient support layer 1016. Additionally, it is understood that instead of being comprised of foam, one or more sections or portions of the bottom member 1028 may be comprised of a gel, fluid or other pressure compensating media, generally referred to as a non-inflatable component. Further, the bottom member 1028 may be comprised of one or more inflatable and/or non-inflatable components. The bottom member 1028 may also be comprised of foam having a plurality of independently projecting foam cells.

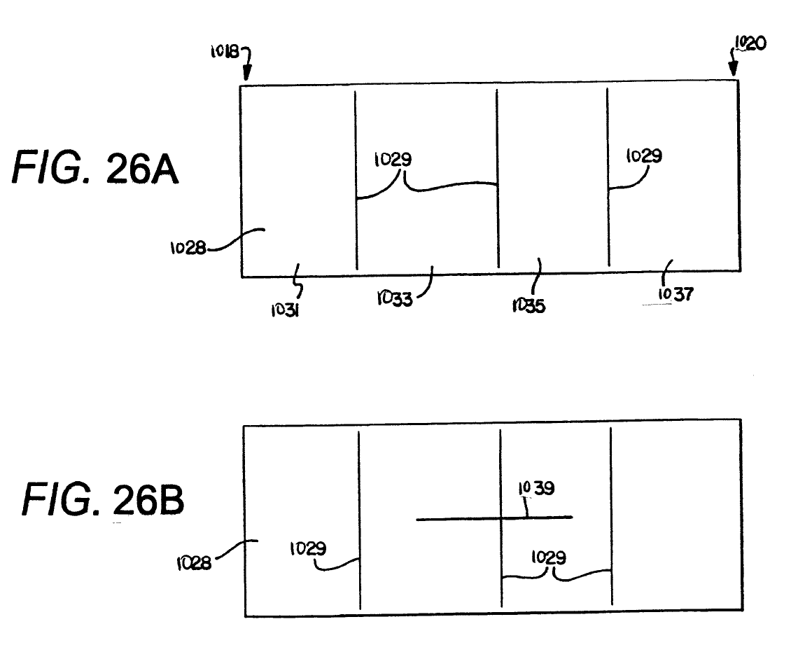

In various embodiments the bottom member 1028 is a substantially flat and unitary member, as shown in FIGS. 21-25. Alternate embodiments of the bottom member 1028 are shown in FIGS. 26A and 26B. In these embodiments, the bottom member 1028 may have various regions at different portions thereof. As shown in FIG. 26A, multiple transverse openings 1029 are provided through the bottom member 1028 to create separate zones thereof to allow more independent movement of the mattress 1010 in each zone. For example, openings 1029 are provided in the bottom member 1029 between the head zone 1031 and the seat zone 1033, between the seat zone 1033 and the knee zone 1035, and between the knee zone 1035 and the foot zone 1037 of the bottom member 1028. More or fewer openings 1029 may be provided in the bottom member 1028 to accomplish the desired result. While the openings 1029 shown in FIG. 26A do not intersect the perimeter of the bottom member 1028, such that the bottom member 1028 remains as a unitary element, it is understood that one or more of the openings 1029 could intersect the perimeter of the bottom member 1028 to separate portions thereof, such as shown in FIG. 26B. FIG. 26B also demonstrates that the bottom member 1028 may have one or more longitudinal openings 1039, including a longitudinal opening 1039 that intersects a transverse opening 1029. Further, independent portions of the patient support member 1016 may be provided on each of the various regions of the bottom member 1028 created by the openings 1029, 1039. It is understood that the side members 1030, 1032 would hold the bottom member 1028 together.

As shown in FIGS. 23 and 24, the opposing side members 1030, 1032 are also preferably made of a high density, high resilient, low compression open cell urethane foam that is fire retardant and is set for medical bedding. In one embodiment the side members 1030, 1032 are approximately 2″ thick by 6.25″ high, and they have an ILD value which is greater than the ILD value of the bottom member 1018. In a preferred embodiment, the ILD value of the side members 1030, 1032 is generally greater than 40, and preferably 65.

In the embodiments shown, the side members 1030, 1032 extend approximately from the head end 1018 of the mattress 1010 to the foot end 1020 of the mattress 1010. The side members 1030, 1032 may be connected to the side edges 1036, 1038 of the bottom member 1028, preferably at the contact surfaces at each side 1022, 1024, respectively, thereof. As shown in FIG. 23, in one embodiment the first side member 1030 is connected to the first side edge 1036 of the bottom member 1028 at the first side 1022 of the bottom member 1028, and the second side member 1032 is connected to the second side edge 1038 of the bottom member 1028 at the second side 1024 of the bottom member 1028. Preferably, any conventional and commercially available adhesive which is compatible with urethane foam and suitable for medical applications may be utilized.

Similarly, the end member 1034 is also preferably made of a high density, high resilient, low compression open cell urethane foam that is fire retardant and is set for medical bedding. In one embodiment, like the side members 1030, 1032, the end member 1034 is approximately 2″ thick by 6.25″ high, and it has an ILD value which is greater than the ILD value of the bottom member 1028. Additionally, in a preferred embodiment the ILD value of the end member 1034 is substantially similar to the ILD value of the side members 1030, 1032, and in a most preferred embodiment the ILD value of the end member 1034 is generally greater than 40, and preferably 65.

As shown in FIG. 23, in one embodiment the end member 1034 may be connected to an end edge 1040 of the bottom member 1028 at the foot end 1020 thereof, and preferably at the contact surface at the foot end 1020 thereof. Additionally, in the embodiments shown, the end member 1034 may extend approximately from the first side 1022 of the mattress 1010 to the second side 1024 of the mattress 1010. In such embodiments a first end 1042 of the end member 1034 is connected to an interior surface at the foot end 1020 of the first side member 1030, and a second end 1044 of the end member 1034 is connected to an interior surface at the foot end 1020 of the second side member 1032. However, in alternate embodiments the connection between the side members and the end member may be varied. Preferably, any conventional and commercially available adhesive which is compatible with urethane foam and suitable for medical applications may be utilized to secure the end member 1034 to the foot end 1020 of the bottom member 1028 and the first and second side members 1030, 1032.

As explained above, a second end member may be provided at the head end 1018 of the mattress 1010. This second end member would typically be secured to the head end 1018 of the bottom member 1028, and the head end 1018 of the first and second side members 1030, 1032, similar to the securement of the first end member 1034 to the foot end 1020 of the bottom member 1028. However, alternate connections are possible as one of ordinary skill in the art would readily understand.

In one embodiment having a perimetral frame 1015 and a bottom member 1028, where the side members 1030, 1032 and the end member 1034 of the base are approximately 6.25″ high and the bottom member 1028 is approximately 3″ high, a cavity or well 1046 that is approximately 3.25″ deep is defined between the bottom member 1028 and the opposing side members 1030, 1032 and end member 1034. Alternate embodiments employing different thicknesses of the bottom member 1028 and different thicknesses of the components making up the perimetral frame 1015 will have different depths of the well or cavity 1046. This cavity 1046 is preferably utilized to house the patient support layer 1016 as explained and shown herein.

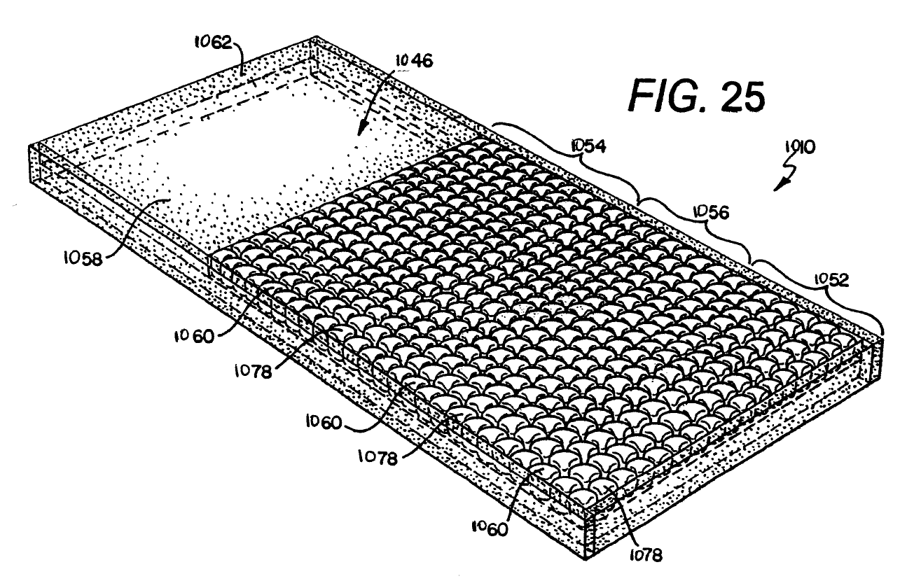

Referring to FIGS. 23 and 25, the patient support layer 1016 is positioned above the base layer 1014, and the patient support layer 1016 generally comprises a plurality of zones or sections to support different portions of a patient's body. For example, in the embodiments of FIGS. 23 and 25, the patient support layer 1016 comprises a head zone 1050 adjacent a head end 1018 of the mattress 1010, a foot zone 1052 adjacent the foot end 1020 of the mattress 1010, a seat zone 1054 adjacent the head zone 1050 at the foot end thereof, and a knee zone 1056 adjacent the head end of the foot zone 1052 at one end and adjacent the seat zone 1054 at the other end thereof. It is understood, however, that a fewer number or greater number of zones of the patient support layer 1016 may be utilized with the present mattress 1010, including zones which do not extend from one side of the mattress to the other side of the mattress, such as can be utilized with the bottom member 1028 as shown in FIG. 26B hereof. Further, the size of each zone may vary.

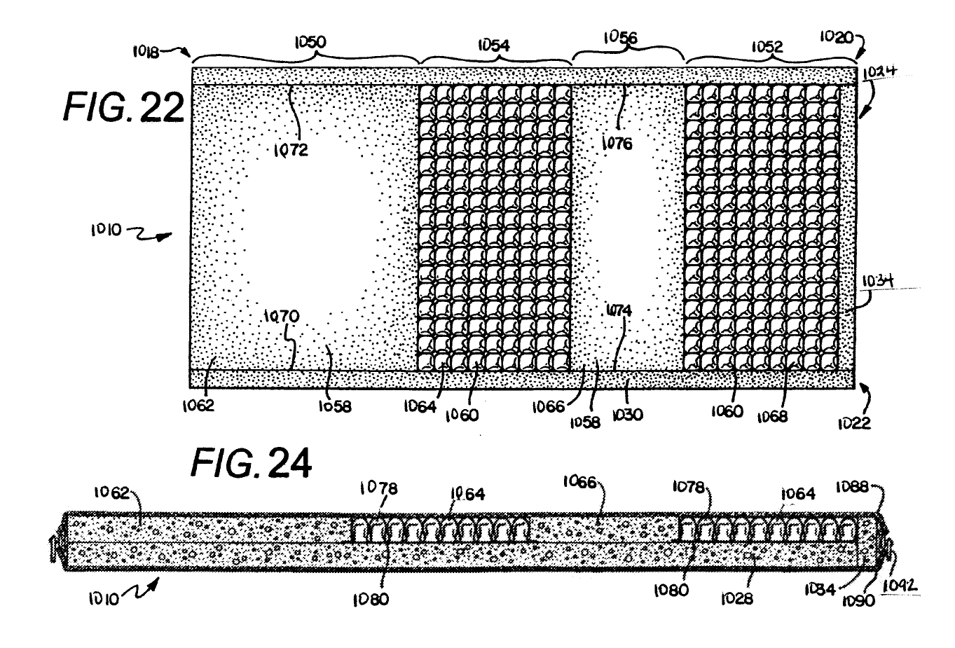

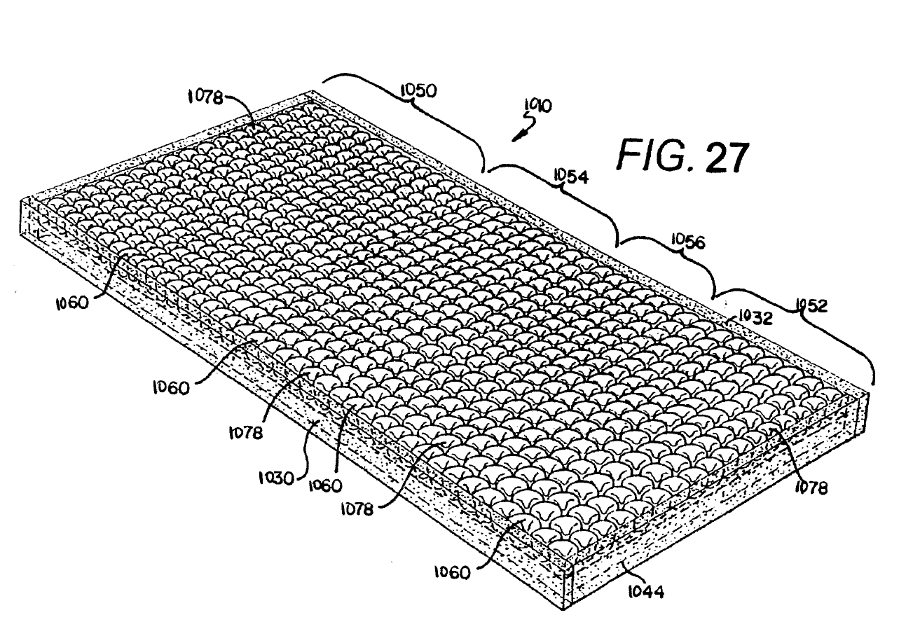

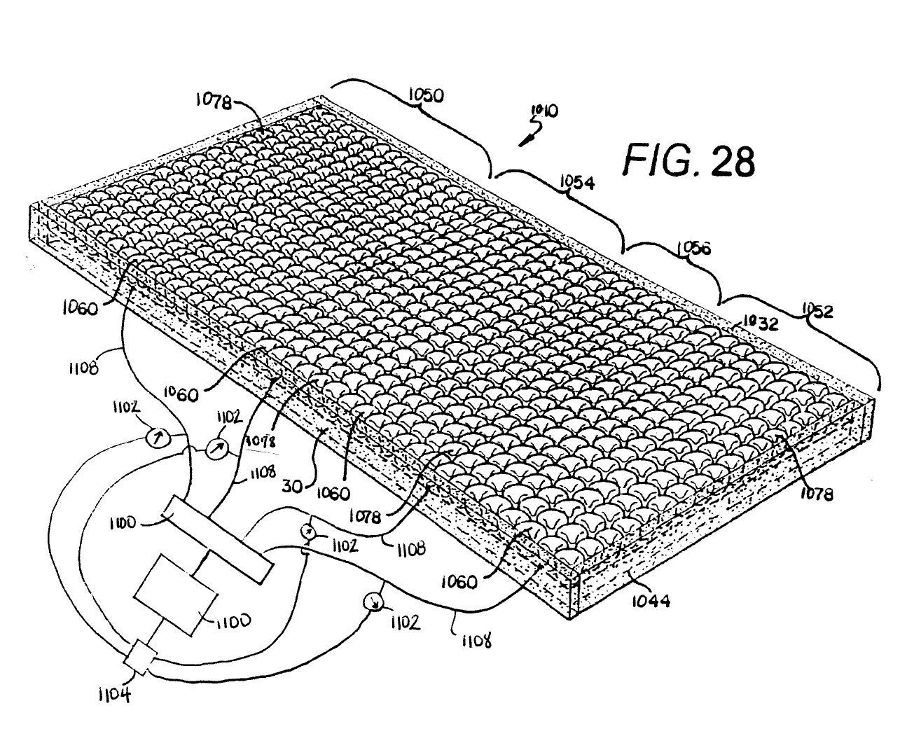

In preferred embodiments, various zones or sections of the patient support layer 1016 are made of an inflatable air mattress component, air cell or air cushion 1060. Additionally, in alternate embodiments one or more of the different zones or sections of the patient support layer 1016 are made of a non-inflatable component 1058. For example, in the embodiment of FIGS. 22 and 23, the portion of the patient support layer 1016 in the head zone 1050 is made of a non-inflatable foam material component 1062, the portion of the patient support layer 1016 in the seat zone 1054 is made of inflatable component 1064, the portion of the patient support layer 1016 in the knee zone 1056 is made of a non-inflatable foam material component 1066, and the portion of the patient support layer 1016 in the foot zone 1052 is made of an inflatable component 1060. Alternately, the different zones or sections of the patient support layer 1016 may be made entirely of inflatable components 1060 (as shown in FIGS. 27 and 28) or entirely of non-inflatable components 1058 (not shown). Further, instead of foam, the non-inflatable components 1058 of the patient support layer 1016 may be comprised of a gel, liquid fluid or some other non-inflatable pressure compensating media.

In one embodiment the air components 1060 comprise a closed-cell section made up of a plurality of independent air cells manufactured by the Roho Group, Belleville, Ill., under the name Dry Flotation®. One version of the Roho Dry Flotation® air component 1060 is approximately 3.5″ tall and approximately 1.5″ in a square cross section. An alternate version of the Roho Dry Flotation® air component 1060 is approximately 2.5″ tall and is approximately 4″ in a square cross section.

While different non-inflatable materials may be utilized without departing from the scope of the present invention, in one embodiment the first foam component 1062 utilized in the head zone 1050 adjacent the head end 1018 of the mattress 1010 is a urethane memory-type foam that is fire retardant and is set for medical bedding. Further, in a preferred embodiment, the foam component 1062 for the head zone 1050 has a density of between 2.0 and 6.0 lbs, and preferably at least 2.5 lbs but generally not greater than 5.0 lbs. Alternately, the foam component 1062 for the head zone 1050 may be referred to as having an ILD value of between 15 and 40 ILD. Additionally, the foam component 1062 for the head zone 1050 has a first side 1070 adjacent the first side member 1030, and a second side 1072 adjacent the second side member 1032. Moreover, in one embodiment the foam component 1062 in the head zone 1050 is approximately 3.25″ thick to fill the cavity or well 1046 of the base layer 1014, which in one embodiment is approximately 3.25″ deep as explained above. Preferably, the ILD value of the foam component 1062 for the head zone 1050 is less than the ILD value of both the bottom member 1028 and the side members 1030, 1032 of the base member 1014. In one embodiment the foam component 1062 for the head zone 1050 is fixed, typically with an adhesive as explained above, to the base layer 1014.

Similarly, in one embodiment the second foam component 1066 utilized in the knee zone 1056 is a urethane memory-type foam that is fire retardant and is set for medical bedding. Further, in a preferred embodiment, the foam component 1066 for the knee zone 1056 has a density of between 2.0 and 6.0 lbs, and preferably at least 2.5 lbs but not greater than 5.0 lbs. Alternately, the foam component 1066 for the knee zone 1056 may be referred to as having an ILD value of between 1015 and 1040 ILD. As shown in FIG. 23, this foam component 1066 for the knee zone 1056 has a first side 1074 adjacent the first side member 1030, and a second side 1076 adjacent the second side member 1032. The foam component 1066 in the knee zone 1056 is also approximately 3.25″ thick to fill the cavity or well 1046 of the base layer 1014. Finally, in a preferred embodiment the ILD value of the foam component 1066 for the knee zone 1056 is less than the ILD value of both the bottom member 1028 and the side members 1030, 1032 of the base member 1014, and is typically the same as the foam component 1062 for the head zone 1050. Further, the foam components for the patient support layer 1016 are typically less rigid than the foam components of the base layer 1014. This foam component 1066 may be secured to either the base layer 1014 or to the other components of the patient support layer 1016.

In one embodiment, a first inflatable air mattress component 1068 is utilized in the foot zone 1052, and a second inflatable air mattress component 1064 is utilized in the seat zone 1054. Alternately, inflatable components 1060 may also be utilized in the head zone 1050 and knee zone 1056. In a preferred embodiment, as shown in the figures, the inflatable components generally comprise a plurality of low-pressure, soft, fluidly interconnected but independently movable, air-filled cells 1078 which are able to redistribute air pressure between each of the cells 1078 in the inflatable component to conform to the contours of a patient's body with minimal tissue deformation to provide a friction and shear relief surface. Such inflatable components are typically provided in a closed system, but may be provided in an open system as described herein. The air cells 1078 are generally arranged in an array of rows and columns which are fluidly connected across a flexible base 1080 on the inflatable components 1060. As explained above, in one embodiment, the air cells 1078 have a substantially rectangular body that is approximately 3.5″ high, with a top wall that has a generally pyramidal or conical shape thereto. Further, the air cells 1078 of this embodiment have a generally square cross-sectional shape. In an alternate embodiment, the air cells 1078 are also arranged in an array of rows and columns which are fluidly connected across a flexible base 1080 on the inflatable components 1060, but the air cells 1078 have a substantially rectangular body that is approximately 2.5″ high, with a top wall that is generally flat or slightly conical, and with a generally square cross-sectional shape of approximately 4″. Further, the air components 1060 may be made of various materials, including, but not limited to, neoprene and urethane. It is also understood that the same type and/or configuration of air components 1060 may not be utilized in each zone or section of the mattress 1010. Instead, a combination of different air components 1060 may be utilized in different sections or zones of the mattress 1010. For example, in one embodiment air component 1060 having the larger air cells 1078 may be utilized in the head, seat and knee sections 1050, 1054 and 1056, and an air component 1060 having the narrower air cells 1078 may be utilized in the foot section 1052 to provide a varied therapeutic benefit for the patient.

Generally, like the foam mattress portions 1058 of the patient support member 1016, the air mattress components 1060 are provided in the cavity or well 1046 of the base layer 1014, and extend from the first side member 1030 to the second side member 1032 of the base layer 1014. Alternately, however, the patient support member 1016 may be provided on the base layer 1014 without any perimetral frame 1015, such as the first side member 1030 and the second side member 1032. In one such embodiment, the cover 1012 provides additional structure to retain the patient support member 1016.

In one embodiment, as disclosed in FIG. 21, the inflatable component 1060 is positioned such that the flexible base 1080 of the inflatable component 1060 is provided adjacent the bottom member of the base layer 1014, and the air cells 1078 project vertically upwardly toward the upper encasing member 1088. In alternate embodiments, multiple components of the inflatable component 1060 may be stacked on one another at various zones of the mattress 1010. For example, in one zone a first or lower inflatable component 1060 may be provided on the bottom member 1028 of the base layer 1014, and a second or upper inflatable component 1060 may be provided on the first inflatable component. Further, the lower inflatable component may be orientated such that its inflatable components are positioned adjacent the bottom member 1028 of the base layer 1014 and its flexible base 1080 is raised off the bottom member 1028. Then, the upper inflatable component is layered on the lower inflatable component by placing the base layer 1014 of the upper inflatable component on the base layer 1014 of the lower inflatable component, and having the inflatable components of the upper inflatable component project upwardly and away from the lower inflatable component. One of ordinary skill in the art would readily understand that additional combinations and orientations of the inflatable components may be utilized, such as having both the upper and lower inflatable components orientated similarly, without departing from the scope or the spirit of the present invention.

The air cells 1078 can be adjusted to the patient's body shape and size. In one embodiment, the inflatable components 1060 are provided in a type of closed system where they are non-powered and require no external power source once they are inflated to the appropriate pressure. Thus, after the inflatable components 1060 are inflated, they are maintained at that pressure, however, should any leakage or seepage occur they may be re-inflated to the desired pressure. In a preferred embodiment, the inflatable components 1060 are made of a durable neoprene or urethane rubber that is flame-resistant and can be easily cleaned. Each of the inflatable components 1060 of the different zones can be removed and replaced, if necessary. The inflatable components 1060 can also be physically connected to adjacent members, including foam members, typically by snapping together, connecting with Velcro, or by some other acceptable means. Additionally, the inflatable components 1060 can be fluidly interconnected to one another via tubing 1108.

In an alternate embodiment as shown in FIG. 28, however, the inflatable components 1060 are fluidly interconnected to an air source, such as a pump 1100, that can control the pressure in the inflatable components 1060. As used herein, the term pump denotes any component that can provide a supply of air, including a blower, pump, air compressor, air reservoir, etc. A discussion of such embodiment is provided herein.

In the embodiment shown in FIGS. 21-24, the patient support layer 1016 comprises alternating foam components 1058 with inflatable components 1060. Specifically, foam components 1058 are provided in the head zone 1050 and knee zone 1056, and inflatable components 1060 are provided in the seat zone 1054 and foot zone 1052. Generally, inflatable components 1060 are utilized to support areas of the patient's body which are most susceptible to bed sores, such as the hips/buttocks and the heels. Accordingly, inflatable components 1060 having air cells 1078 are provided in these zones 1052, 1054. Conversely, in the embodiment shown in FIG. 25, the patient support layer 1016 comprises a single foam component 1058 in the head zone 1050, with inflatable components 1060 in each of the seat zone 1054, knee zone 1056 and foot zone 1052. Such an embodiment may be utilized with patients that need additional pressure relief in the knee zone 1056, or for patients in which the first embodiment described above is not satisfactory.

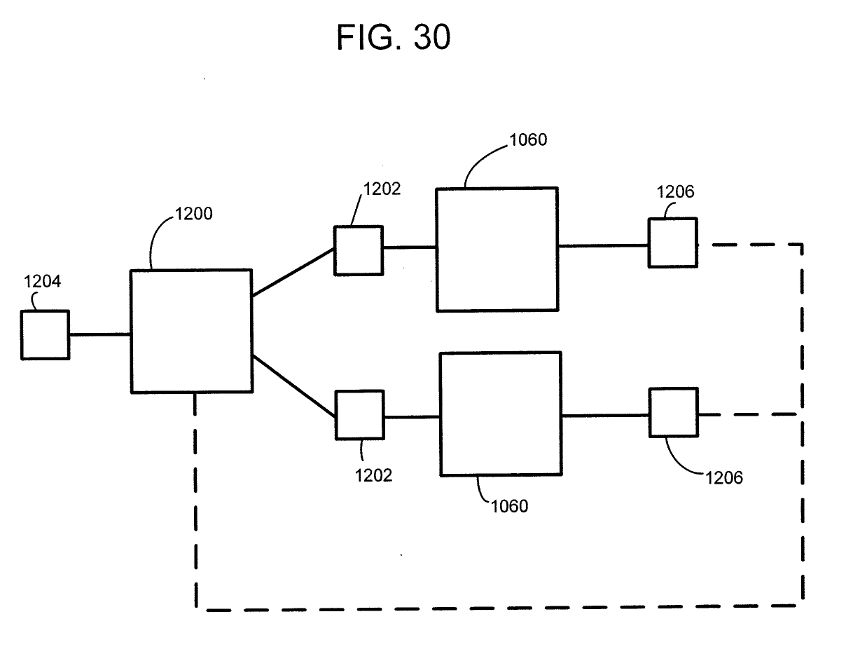

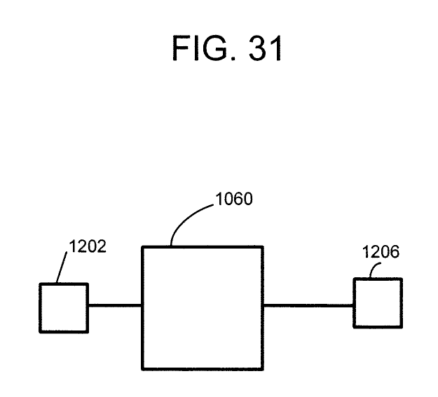

In any of the embodiments described herein, the air or inflatable components 1060 may be automatically adjustable or not automatically adjustable. If not automatically adjustable, the air components 1060 are generally inflated to a certain pressure and sealed. The air pressure in the air components 1060 is manually checked periodically and manually adjusted, if necessary, to ensure that the therapeutic benefit of the air component 1060 is being provided. Alternately, as explained herein, the air component 1060 may be automatically adjustable, meaning that it may be fluidly connected to an variety of air sources, such as a pump 1100 as shown in FIG. 28 or an air reservoir 1100 as shown in FIG. 30, for automatic operation/adjustment of the mattress. Further yet, in another alternate embodiment shown in FIG. 31, valves may be connected to the air components to automatically adjust the air pressure in the air components.

In a preferred embodiment of the adjustable/powered system as shown in FIG. 28, one or more of the air components 1060 are fluidly connected to a pump 1100. The pump 1100 may be integral with the mattress 1010, such as, for example, being housed in the mattress 1010, including in the base member 1028 of the mattress 1010, or the pump 1100 may be an auxiliary pump that is housed outside the mattress 1010, for example fluidly connected adjacent the head end of the mattress 1010, such that air is plumbed to the mattress components. Additionally, the pump 1100 may be housed in the frame of the bed or some other location in the bed.

Additionally, a device 1102 to measure the pressure in each of the air components 1060, such as a pressure sensor/gauge or manometer, is provided. Alternately, the pressure sensor 1102 could be a barometer, aneroid, bourdon or any other pressure sensor, either electrically or non-electrically operated, such as pneumatic or mechanical, as known to those skilled in the art of measuring pressures. The pressure sensor 1102 may be integral with or separate from the pump 1100.

In one embodiment a controller 1104 is also utilized in the system. Preferably, the controller 1104 controls operation of the pump 1100. The controller 1104 may be integral with the pump 1100. Alternately, the controller 1104 may be separate from the pump 1100. Further yet, the air pressure in the air components 1060 may be determined via the pump 1100, such as for example via software in either the pump 1100 or in a separate controller 1104. In one embodiment the controller 1104 receives a signal from the pressure sensor 1102. The signal from the pressure sensor 1102 may be of the measured air pressure, the differential air pressure, or any other relevant measurement. Preferably, the differential air pressure is measured and provided as the difference between the air pressure in the air component 1060 and atmospheric air pressure. Based on the received signal from the pressure sensor 1102, the controller 1104 may operate the pump 1100 to alter or vary the air pressure in any one or more of the air components 1060. For example, if the air pressure is too high in a specific air component 1060, including after a user is positioned on the mattress, the controller 1104 may open the valve 1106 to bleed air from the air component 1060 until the desired pressure is attained. Alternately, if the air pressure is too low in a specific air component after a user is positioned on the mattress the controller 1104 may actuate the pump 1100 and direct air into that air component 1060 until the desired pressure is attained. Thus, the use of a pump 1100, controller 1104, and valve 1106 in the system may also allow for the adjustment of the desired air pressure in each air component 1060. Further, the controller 1104 may run tests on the air components 1060 to determine if there is a leak in the system. And, the controller 1104 may allow for entering the height and weight of the patient to individually adjust the desired allowable pressure ranges for the air components 1060. All of these features may be accomplished by programming of the controller 1104 or software for the pump 1100. It is understood that the controller 1104 may be either an integral component of the pump 1100, or it may be an accessory to the system.

Preferably, in one embodiment a single pump 1100 is fluidly connected to a plurality of air components 1060. To accomplish having a plurality of air components 1060 connected to a single pump or air compressor 1100, a valve 1106 is utilized to direct air from the pump 1100 to the appropriate air component 1060. Additionally, tubing 1108 is utilized to individually direct air from the valve 1106 to each air component 1060. Having a pump 1100 connected to the air components 1060 allows the system to adjust the air pressure in any connected air component 1060 to generally any desired air pressure.

In a preferred method of operation of the powered therapeutic mattress system, the air components 1060 are initially maintained at a pressure slightly above ambient atmospheric pressure with no patient on the air components 1060, such as approximately 1-3 mmHg. It has been observed that with the air components 1060 at approximately 1-3 mmHg in the ambient state, after a patient is placed on the air components 1060 the pressure increases to approximately 17 mmHg above ambient atmospheric pressure, which generally provides proper therapeutic benefit to the patient. Atmospheric pressure is generally defined as the force per unit area exerted against a surface by the weight of air above that surface at any given point in the Earth's atmosphere. Low pressure areas have less atmospheric mass above their location, whereas high pressure areas have more atmospheric mass above their location. Similarly, as elevation increases there is less overlying atmospheric mass, so that pressure decreases with increasing elevation. Generally, one standard atmosphere is equal to approximately 1029.53 in Hg or about 1014.3 PSI, which equates to about 745 mmHg. In a preferred embodiment of the powered therapeutic mattress, however, as explained above, the difference in the air pressure from atmospheric air pressure is measured.

As explained above, with no patient on the mattress the differential air pressure measurement in the air components 1060 is preferably maintained at approximately 1-3 mmHg, however, the air component 1060 may be maintained at a different pressure with no patient on the mattress as desired. When a patient is placed on the mattress the air pressure in the air components 1060 will increase due to the decrease in the volume of the air components 1060. After a period of time, such as between 1030 seconds and 2 minutes, preferably when the patient has come to a state of rest, the system will take an initial reading of the differential air pressure in the various air components 1060. The initial reading may be referred to as the set point. In one embodiment the controller 1104 will compare the set point value to a range of values to determine if the set point value is within the acceptable differential air pressure range, below the acceptable differential air pressure range, or above the acceptable differential air pressure range. In one embodiment the acceptable differential air pressure range is from approximately 17 mmHg to approximately 25 mmHg. Accordingly, in this embodiment the low end of the acceptable differential air pressure range is approximately 17 mmHg above atmospheric pressure, and the high end of the acceptable differential air pressure range is approximately 25 mmHg, however the low end and the high end of the range may be adjusted as deemed appropriate. Thus, if the set point is determined to be above 25 mmHg the controller 1104 will operate to have air bled out of the air component 1060 until the measured air pressure in the air component 1060 is determined to be within the acceptable differential air pressure range. Conversely, if the set point is determined to be below 17 mmHg the controller 1104 will operate to have air pumped into the air component 1060 until the measured air pressure in the air component 1060 is determined to be within the acceptable differential air pressure range. Of course, alternate acceptable pressure ranges may be utilized without departing from the scope and spirit of the present invention.

After the initial adjustment period to place the differential air pressure in the air components 1060 within the acceptable differential air pressure range, the system will operate to frequently monitor the pressure within the air components 1060 to confirm that the air components 1060 are maintained at the appropriate air pressure. In one embodiment, the system will sample the air pressure in the air components 1060 every 10 seconds. The sample rate may be increased or decreased depending on the tuning specifications required.

Frequent monitoring of the air pressure within the air components 1060 will also assist in determining if any of the air components 1060 is faulty, such as by having a leaky valve or a tear in the air component 1060, which will cause the air pressure in the air components to decrease. Frequent monitoring of the air pressure within the air components 1060 will also assist in confirming that the appropriate therapeutic benefit is being provided to the patient, and should preclude bottoming out of the patient. Preferably, the system will include a bottoming out sensor that will send a signal to either the controller 1104 or the pump 1100 to adjust the air pressure in the identified air component 1060.

One aspect of the patient monitoring will be to determine if the patient has exited one or more air components 1060 of the mattress. When the patient exits the mattress the air pressure in the air components 1060 will decrease due to the increase in the volume of the air components 1060. Accordingly, it will be preferred if the system could differentiate between a problem with one of the air components 1060, i.e., such as a tear in one of the air components 1060, and the patient merely exiting one or more of the air components 1060 of the mattress. Preferably, when a large decrease in the pressure of one of the air components is observed, the controller 1104 will operate to have the pump 1100 increase the air pressure in the air component 1060 to a maximum pressure. In one embodiment the maximum pressure is approximately 40 mmHg above atmospheric pressure. The system will then monitor the air pressure in that air component 1060. If after a period of time, such as between 30 seconds and 2 minutes, the pressure in the air component remains at the maximum pressure then the system will have determined that there is no problem with the air component 1060, and instead the prior observed pressure decrease was due to the patient exiting that air component 1060. Accordingly, in that situation the controller 1104 will operate to have the air pressure in that air component 1060 adjusted back to within the acceptable range, such as approximately 17 mmHg above atmospheric pressure if a patient is on the air component 1060 and 1-3 mmHg if no patient is on the air component 1060. If, however, the air pressure measured in the air component 1060 after the period of time has elapsed is determined to be lower than the maximum pressure, then the system will determine that there is a malfunction in the air component 1060 and an alarm will be set off to alert that operator that the air component 1060 is faulty.

While the above example utilized 17 mmHg as the preferred setting for the differential air pressure of the air components 1060 after a patient is positioned on the air component 1060, it is understood that the system may allow for entering the height and weight of the patient into the controller 1104 so that the controller 1104 may adjust the air pressure of each air component 1060 based on the specific patient parameters to provide a preferred therapeutic benefit. It is also understood that the preferred air pressure in the different zones of the mattress may be varied within a single mattress 10 to provide the preferred therapeutic benefit in each zone.

While the above embodiment has been described to include a pump 1100, as explained above it is understood that any air source will be acceptable. For example, a compressor may be utilized. Alternately, an air reservoir may be utilized to provide the source of air to the air components 1060, thereby eliminating the need for a powered system.

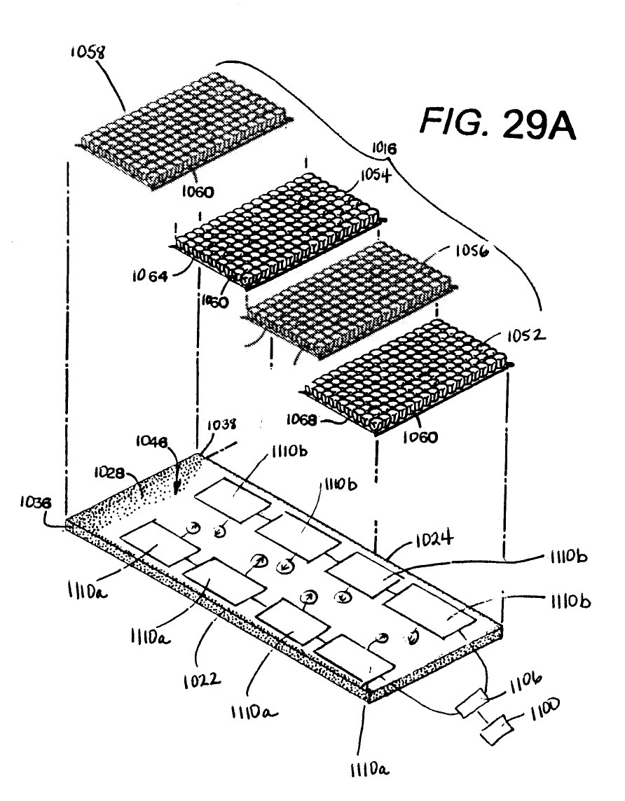

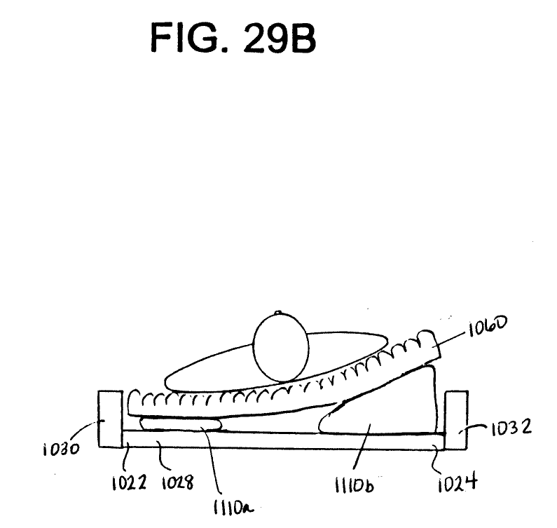

Additionally, as shown in FIGS. 29A and 29B, another embodiment of the powered air mattress is shown. In the embodiment of FIGS. 29A and B, a plurality of rotation or turning bladders 1110 are provided. Generally, at least one turning bladder 1110a is provided adjacent a first side 1022 of the mattress, and at least another turning bladder 1110b is provided adjacent the second side 1024 of the mattress. In one embodiment, different turning bladders are provided at the first and second sides 1022, 1024 of each zone of the mattress 1010. Accordingly, in one embodiment the mattress 1010 may include a first turning bladder 1110a adjacent the first side 1022 of the mattress 1010 in the head zone 1050, a second turning bladder 1110b adjacent the second side 1024 of the mattress 1010 in the head zone 1050, a third turning bladder 1110a adjacent the first side 1022 of the mattress 1010 in the seat zone 1054, a fourth turning bladder 1110b adjacent the second side 1024 of the mattress 1010 in the seat zone 1054a, a fifth turning bladder 1110a adjacent the first side 1022 of the mattress 1010 in the knee zone 1056, a sixth turning bladder 1110b adjacent the second side 1024 of the mattress 1010 in the knee zone 1056, a seventh turning bladder 1110a adjacent the first side 1022 of the mattress 1010 in the foot zone 1052, and an eighth turning bladder 1110b adjacent the second side 1024 of the mattress 1010 in the foot zone 1052. The turning bladders 1110a, 1110b are generally powered by the pump 1100 to assist in turning or rotating the patient. For example, a left rotation turn of the patient is accomplished by inflation of one or more of the first side turning bladders 1110a through a first hose 1108 from the valve block 1106 while simultaneously exhausting air in the second side turning bladders 1110b through a second hose 1108 from the valve block 1106. Conversely, a right rotation turn of the patient is accomplished by inflation of one or more of the second side turning bladders 1110b through the second hose 1108 from valve block 1106 while simultaneously exhausting air in the first side turning bladders 1110a through the first hose 1108 from valve block 1106. Additionally, a pressure sensor 1102 may be connected to each rotation bladder 1110a, 1110b to monitor the air pressure in each bladder 1110a, 1110b. Generally, the controller 1104 controls the flow of air to/from each turning bladder 1110a, 1110b.

In a preferred embodiment the turning bladders 1110a, 1110b are provided below the air components 1060, and above the bottom member 1028 of the mattress 1028, as shown in FIG. 29B. The air bladders 1110a, 1110b may have a triangular shape, as shown in FIG. 29B, or they may have a circular shape, or they may have another geometric shape to provide the necessary turning of the patient. Additionally, angle sensors (not shown) may be provided to monitor the angle of the mattress 1010. Finally, bottoming out sensors (not shown) may be provided under the various air components 1060 to provide an alert to the controller 1104 that the air components 1060 are not pressurized as needed. The bottoming out sensors may include capacitance type sensors to provide height or immersion control by sensing through the lower layer of the air components 1060 to determine immersion of the patient on the air component 1060. Alternately, the bottoming out sensors may include a pressure type sensor. Additionally, it is noted that the embodiment of FIG. 29B incorporates side frame members 1030, 1032, whereas the embodiment of FIG. 29A does not incorporate a perimetral frame 1015.

Referring now to FIG. 30, there is shown an embodiment of an automatically adjustable mattress 1010 utilizing an air reservoir 1200 to provide the source of air to the mattress 1010 for automatic operation/adjustment of the air pressure of each air component 1060 in the mattress 1010. As schematically illustrated, an air reservoir 1200, such as an air tank, is provided and is fluidly connected to each air component section 1060. In one embodiment the air reservoir 1200 is a two gallon tank that preferably retains up to 100 mmHg of air pressure. The air reservoir 1200 may be retained within the air mattress to provide a completely internal system, or the air reservoir 1200 may be provided outside the air mattress but fluidly connected to the air mattress 10. Additionally, a fill valve 1202 with a regulator is provided on the inlet side for each air component 1060 section, and a vent or exit valve 1206 with a regulator may be provided for each air component 1060 section on the outlet side for each air component 1060 section. Alternately, a single inlet valve/regulator 1202 may be provided for multiple air component 1060 sections, and/or a single exit valve/regulator 1206 may be provided for multiple air component 1060 sections. Each fill valve/regulator 1202 is fluidly connected in line between the reservoir 1200 and the respective air component 1060 section. Additionally, in a preferred embodiment the fill valves 1202 are one way valves that allow air to be provided into the air component 1060 sections, while preventing air from escaping out of the air component 1060 sections via the fill valves 1202.

As explained above, in a preferred embodiment each air component 1060 section is preferably set to an air pressure of approximately 1-3 mmHg above atmospheric pressure in the ambient state of each air component 1060 section. To maintain such setting, the regulators are preset to allow air to pass from the reservoir 1200 and through the one-way valves 1202 when the pressure observed by the regulator is less than 1-3 mmHg above atmospheric pressure. Preferably, the regulators are adjustable to allow for different settings either greater or less than 1-3 mmHg above atmospheric pressure.

In such a system the reservoir tank 1200 has a gauge 1204 to provide a readout of the air pressure in the reservoir tank 1200. The system may also have an alarm that provides an audible or visual alert that the air pressure in the reservoir tank 1200 has reached a minimum threshold level and should be increased to continue to maintain the system in operation. It is expected in the present system that the reservoir tank 1200 should maintain sufficient air pressure to operate a mattress 1010 system containing four air component 1060 sections at 1-3 mmHg above ambient atmospheric pressure for a sufficient period of time, such as up to 6 months. Accordingly, the air pressure in the reservoir tank 1200 will be maintained at a first pressure greater than the second pressure of air inside the air components 1060. An operator should check the reservoir tank 1200 gauge 1204, however, periodically to ensure that sufficient pressure is retained in the reservoir tank 1200 to operate the mattress 1010 system. When the air pressure in the reservoir tank 1200 decreases below a certain threshold greater than the air pressure in the air components 1060, the air pressure in the reservoir tank 1200 can be increased through a common compressor. Accordingly, such a system provides a purely mechanical fluid system to retain the air component 1060 sections of the air mattress 10 at an appropriate level.

Additionally, the vent valves/regulators 1206 are adjustable to allow air to automatically and independently exit out of the air component 1060 sections as required. As explained herein, in one embodiment the acceptable differential air pressure range is from approximately 17 mmHg to approximately 25 mmHg when the patient is on the air component 1060. Accordingly, in such an embodiment the high end of the acceptable differential air pressure range is approximately 25 mmHg. Thus, if the pressure sensed by the vent valve/regulator 1206 in an air component 1060 exceeds 25 mmHg the vent valve 1206 will operate to open and bleed air from the air component 1060 section until the sensed pressure in the air component 1060 section determined to be at or below 25 mmHg.

In different embodiments the air that exits the air component 1060 may be exhausted to the environment (in an open system) or it may be retained within the system (in a closed system). For example, in one embodiment of a closed system as shown in dotted lines in FIG. 30, the air reservoir 1200 may be maintained at a first pressure which is greater than a second pressure of the air pressure in the air components 1060 in the ambient state (i.e., with no patient on the air components 1060). In one such embodiment the air pressure in the air components 1060 in the ambient state is approximately 1-3 mmHg. Accordingly, the air pressure in the air reservoir 1200 may be maintained at some pressure above 1-3 mmHg, such as 20 mmHg to allow air to flow from the air reservoir 1200 into the air components 1060 when the entrance regulator senses an air pressure in the air components 1060 of less than 1-3 mmHg and the entrance valve 1202 is opened. Conversely, if the air pressure in the air components 1060 reaches a level above the acceptable level, such as above 25 mmHg in one embodiment, air will be released out of the air components 1060 through the exit valves 1206 and will be piped directly into the air reservoir 1200 which is maintained at a lower air pressure. In such an embodiment the system would be generally self-maintaining.

It is understood that piping or tubing generally fluidly connects the air reservoir 1200 with the air components 1060 in all embodiments on the entrance side of the air components 1060, and in a closed systems such as the embodiment just described tubing will also fluidly connect the air components 1060 with the air reservoir 1200 on the exit side as well. It is further understood that a single valve/regulator 1202 may be used to monitor air pressure in multiple air components 1060, thereby maintaining the pressure in each air component 1060 the same. If it is desired to maintain air pressure in various air reservoirs 1060 different, for example it may be desirable to maintain the air pressure in the seat section less than the air pressure in the foot section, individual valve/regulators 1020 may be utilized for each air component 1060 section. Alternately, if the initial pressure is desired to remain the same in each air component section 1060, but there is a concern that certain sections may see higher internal pressures in use due to various parts of the body being heavier than others (i.e., higher in use pressures in the seat section versus the foot section), different air component 1060 sections may have separate exit valves/regulators 1206 to allow air to be bled off different air component 1060 sections independently and/or at different maximum pressures. In such a scenario where different air component 1060 sections may be at different pressures during use, it may be desirable to either not have all of the air component 1060 sections plumbed together at the entrance, or if they are all plumbed together to maintain a minimum pressure they may have one-way check valves in-line to prevent air from flowing from one air component 1060 section into another air component 1060 section.

Yet, in another alternate embodiment of the automatically adjustable mattress system is shown in FIG. 31. In the system of FIG. 31, valves/regulators 1202, 1206 are provided at the entrance and exit to each air component 1060 section, but no pressurized air source is provided, only atmospheric air. In a preferred embodiment the valves 1202, 1206 are one-way valves. Accordingly, the valve 1202 at the entrance to each air component 1060 section allows air to flow into the air component 1060 section from the atmosphere and precludes air from flowing out of the air component 1060 section, and the valve 1206 at the exit to each air component 1060 section allows air to flow out of the air component 1060 section and precludes air from flowing into the air component 1060 section. The regulators for each valve 1202, 1206 can be independently adjusted and set to open the valves 1202, 1206 at different pressures. For example, the regulator connected to an exit valve 1206 to the air component 1060 sections can be set to open the exit valve 1206 when the measured relative pressure in the air component 1060 section is sensed as being above a certain threshold, such as 25 mmHg above ambient atmospheric pressure. In such a situation this will allow air to escape through the exit valve 1206 and will prevent the air component 1060 from exerting too much pressure on a large patient that may be on the mattress 10. The exit valve will close when the measured air pressure in the air component 1060 returns to a level below 25 mmHg above atmospheric pressure. Similarly, the regulator connected to an entrance valve 1202 to the air component 1060 section can be set to open the entrance valve 1202 when the measured relative pressure in the air component 1060 section is sensed as being below atmospheric pressure (i.e., 0 mmHg) with no patient on the mattress 1010. In such a situation this will allow air to transfer from the atmosphere into the air component 1060 section until the measured relative pressure in the air component 1060 section reaches atmospheric pressure. At that time the regulator will operate to close the entrance valve 1202.

Referring now to FIGS. 30 and 34, as well as all other embodiments, the entire base member 1014, perimetral frame 1015 and patient support member 1016 may be housed in a cavity 1086 of the removable encasing 1012. Typically the encasing 1012 comprises a top or upper encasing member 1088 and a bottom or lower encasing member 1090. The top encasing member 1088 is connected to the bottom encasing member 90 with a connector 1092, such as a zipper 1092, generally positioned about the mid-line of the side walls 1030, 1032 of the mattress 1010. In a preferred embodiment, the top encasing member 1088 is made of a breathable (i.e., air permeable) stretch material that is coated with a material, such as urethane, to make it substantially impervious to water. Additionally, the material of the top encasing member 1088 should be stretchy, so as not to provide unacceptable shear for the patient. In a preferred embodiment the material of the top encasing member 1088 is made of a polyurethane coated nylon/spandex material. In a preferred embodiment, the stretch material is made of a 1080% nylon and 1020% spandex blend, such as LYCRA. The bottom encasing member 1090, however, is generally made of 1200 denier double-sided nylon coated urethane. Opposing parts of the zipper 1092 are connected to the appropriate top and bottom encasing members 1088, 1090.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. Additionally, the terms “first,” “second,” “third,” and “fourth” as used herein are intended for illustrative purposes only and do not limit the embodiments in any way. Further, the term “plurality” as used herein indicates any number greater than one, either disjunctively or conjunctively, as necessary, up to an infinite number. Additionally, the term “having” as used herein in both the disclosure and claims, is utilized in an open-ended manner.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind without significantly departing from the spirit of the invention and the scope of protection is only limited by the scope of the accompanying Claims.

What is claimed is:

1. A therapeutic mattress, comprising:
a base member;
a first longitudinal sidewall adjacent a first side of the base member, and a second longitudinal sidewall adjacent a second side of the base member forming a well with the base member;
a patient support layer within the well, the patient support layer having a plurality of separately zoned sections, including a head zone adjacent a head end of the mattress, a foot zone adjacent a foot end of the mattress, and a seat zone between the head zone and the foot zone, wherein the patient support layer in the head zone comprises a first separate and independent air cell section extending generally from the first sidewall to the second sidewall, wherein the patient support layer in the seat zone comprises a second separate and independent air cell section extending generally from the first sidewall to the second sidewall, and wherein the patient support layer in the foot zone comprises a third separate and independent air cell section, wherein each air cell section comprises a plurality of individual air cell members fluidly interconnected to be self-equalizing, each of the air cell members having a sidewall extending vertically from a bottom of the air cell member and terminating in a top wall of each air cell member, each air cell member having a height extending from the bottom of the air cell member to the top wall of the air cell member, and each air cell member of the air cell sections also being independently moveable in a plurality of directions, including the x, y and z directions, and wherein each air cell section is independently inflatable and deflatable with respect to the air cell sections in other zones of the mattress to independently set and adjust an air pressure of each air cell section;
an air source to provide pressurized air, the air source being fluidly connected to each air cell section; and,
a separate adjustably regulated entrance valve in line between the air source and each air cell section to independently increase the air pressure in the air cell sections.

2. The therapeutic mattress of claim 1, wherein the air source is a non-powered pressurized air reservoir.

3. The therapeutic mattress of claim 2, further comprising a gauge to measure the air pressure inside the air reservoir.

4. The therapeutic mattress of claim 1, further comprising an alarm connected to the air source to provide an alert that the air pressure inside the air source has reached a minimum threshold.

5. The therapeutic mattress of claim 1, further comprising an adjustably regulated exit valve at the exit of each air cell section.

6. The therapeutic mattress of claim 5, wherein the adjustably regulated exit valve is also fluidly connected to the air source.

7. The therapeutic mattress of claim 5, wherein the entrance valve opens at a first air pressure lower than a second air pressure required to open the exit valve.

8. The therapeutic mattress of claim 1, wherein the air pressure inside the air source is greater than the air pressure inside each of the air cell sections.

9. The therapeutic mattress of claim 1, wherein the air cell sections extend generally from the first sidewall to the second sidewall.

10. The therapeutic mattress of claim 1, wherein the air source is an air reservoir internal to the mattress.

11. The therapeutic mattress of claim 1, wherein the air source is a pump.

12. The therapeutic mattress of claim 11, further comprising a plurality of turning bladders between the base and the air cell sections, the turning bladders being fluidly interconnected to the pump to assist in inflating and deflating the turning bladders.

13. A therapeutic mattress, comprising:
a base member and first and second opposing longitudinal foam sidewalls extending upwardly to define a well;
a patient support member positioned in the well, the patient support member having a non-air cushion portion and an air cushion portion adjacent the non-air cushion portion, wherein the non-air cushion portion and the air cushion portion extend from approximately the first sidewall to the second sidewall, the air cushion portion comprising a plurality of air cushion members, each air cushion member having a plurality of rows and columns of vertically extending, fluidly interconnected and self-equalizing air cells, the air cells being connected to a base of the air cushion member and extending vertically upward and generally perpendicular to the base of the air cushion member, the air cells further being independently moveable in a plurality of directions;
an air source to provide pressurized air, the air source being fluidly connected to each air cushion member;
an air pressure sensor to measure the relative air pressure in the air cushion members; and,
an entrance valve in line between the air source and each air cushion member to increase the air pressure in the air cushion members.

14. The therapeutic mattress of claim 13, further comprising a separate air pressure sensor and entrance valve for each air cushion member to independently adjust the air pressure in each air cushion member.

15. The therapeutic mattress of claim 13, further comprising a cover encasing the mattress.

16. The therapeutic mattress of claim 13, further comprising a separate regulated exit valve connected to each air cushion member to bleed air from the air cushion member when the sensed air pressure in the air cushion member exceeds a threshold value.

17. The therapeutic mattress of claim 13, wherein the air source is a pressurized air reservoir.

18. The therapeutic mattress of claim 13, wherein the air source is a pump.

19. A therapeutic mattress, comprising:
a base member;
a patient support member positioned on the base member, the patient support member having a plurality of air cell sections, wherein each air cell section comprises a plurality of rows and columns of vertically extending, fluidly interconnected and self-equalizing air cells, the air cells being connected to a base of the air cell section and extending vertically upward and generally perpendicular to the base of the air cell section, the air cells further being independently moveable in a plurality of directions;
an air source to provide pressurized air, the air source being fluidly connected to each air cell section;
an air pressure sensor to measure the relative air pressure in the air cell sections;
a one-way entrance valve in-line between the air source and each air cell section to increase the air pressure in the air cell sections, the air pressure sensor operating to open and close the entrance valve; and,
separate one-way exit valves connected to each air cell section.

20. The therapeutic mattress of claim 19, wherein each air cell section is independently inflatable by the air source to independently adjust an air pressure of each air cell section.
